(19) United States
(12) Patent Application Publication
(10) Pub. No.: US 2025/0245488 A1
(43) Pub. Date: Jul. 31, 2025

(54) NEURAL NETWORK WITH A VARIABLE NUMBER OF CHANNELS AND METHOD OF OPERATING THE SAME

(71) Applicant: HUAWEI TECHNOLOGIES CO., LTD., Shenzhen (CN)

(72) Inventors: Elena Alexandrovna Alshina, Munich (DE); Ahmet Burakhan Koyuncu, Munich (DE); Alexander Alexandrovich Karabutov, Munich (DE); Timofey Mikhailovich Solovyev, Munich (DE)

(73) Assignee: HUAWEI TECHNOLOGIES CO., LTD., Shenzhen (CN)

(21) Appl. No.: 19/182,807

(22) Filed: Apr. 18, 2025

Related U.S. Application Data
(63) Continuation of application No. PCT/EP2023/074895, filed on Sep. 11, 2023.

(30) Foreign Application Priority Data
Oct. 20, 2022 (WO) PCT/EP2022/079255

(51) Int. Cl. G06N 3/0455; H04N 19/51

(52) U.S. Cl. CPC G06N 3/0455; H04N 19/51

(57) ABSTRACT

A neural network including a first neural network layer and a second neural network. The first neural network obtains a first number of channels Cᵢₙ as input and outputs a second number of channels Cₒᵤₜ, where the first number of channels is different from the second number of channels, and Cₒᵤₜ=p*Cᵢₙ/q, and where Cᵢₙ is a multiple of q, and Cᵢₙ, Cₒᵤₜ, p, and q are integers. The second neural network layer obtains the second number of channels Cₒᵤₜ as input.

### CROSS-REFERENCE TO RELATED APPLICATIONS

This application is a continuation of International Application No. PCT/EP2023/074895, filed on Sep. 11, 2023, which claims priority to International Patent Application No. PCT/EP2022/079255, filed on Oct. 20, 2022. The disclosures of the aforementioned applications are hereby incorporated by reference in their entireties.

### FIELD

Embodiments of the present disclosure generally relate to the field of encoding and decoding data based on a neural network architecture including methods and apparatuses for such encoding and decoding images and/or videos from a bitstream using a plurality of processing layers.

### BACKGROUND

Hybrid image and video codecs have been used for decades to compress image and video data. In such codecs, a signal is typically encoded block-wise by predicting a block and by further coding only the difference between the original block and its prediction. In particular, such coding may include transformation, quantization, and generating the bitstream, usually including some entropy coding. Typically, the three components of hybrid coding methods—transformation, quantization, and entropy coding—are separately optimized. Modern video compression standards like High-Efficiency Video Coding (HEVC), Versatile Video Coding (VVC) and Essential Video Coding (EVC) also use transformed representation to code residual signals after prediction.

Recently, neural network architectures have been applied to image and/or video coding. In general, these neural network (NN) based approaches can be applied in various different ways to image and video coding. For example, some end-to-end optimized image or video coding frameworks have been discussed. Moreover, deep learning has been used to determine or optimize some parts of the end-to-end coding framework such as selection or compression of prediction parameters or the like. Besides, some neural network based approaches have also been discussed for usage in hybrid image and video coding frameworks, e.g. for implementation as a trained deep learning model for intra or inter prediction in image or video coding.

The end-to-end optimized image or video coding applications discussed above all have in common that they produce some feature map data, which is to be conveyed between encoder and decoder.

Neural networks are machine learning models that employ one or more layers of nonlinear units based on which they can predict an output for a received input. Some neural networks include one or more hidden layers in addition to an output layer. A corresponding feature map may be provided as an output of each hidden layer. The corresponding feature map of each hidden layer may be used as an input to a subsequent layer in the network, i.e., a subsequent hidden layer or the output layer. Each layer of the network generates an output from a received input in accordance with current values of a respective set of parameters. In a neural network that is split between devices, e.g. between encoder and decoder, a device and a cloud, or between different devices, a feature map at the output of the place of splitting (e.g. a first device) is compressed and transmitted to the remaining layers of the neural network (e.g. to a second device).

Further improvement of encoding and decoding using trained network architectures may be desirable.

### SUMMARY

According to a first aspect, a neural network comprising a first neural network layer and a second neural network is provided. The first neural network is configured to obtain (receive) a first number of channels Cᵢₙ as input and output a second number of channels Cₒᵤₜ, wherein the first number of channels is different from the second number of channels, and Cₒᵤₜ=p*Cᵢₙ/q, wherein Cᵢₙ is a multiple of q, and Cᵢₙ, Cₒᵤₜ, p and q are (positive) integers. The second neural network layer is configured to obtain (receive) the second number of channels Cₒᵤₜ as input. For example, the Cᵢₙ input channels may be or comprise color components, for example, RGB or YGB color components. The Cₒᵤₜ output channels are in latent space, as described in more detail below. For example, the integer q equals to 2. In some implementations, p/q=5/2 or p/q=2.

Contrary to the art, the neural network according to the first aspect guarantees that the number of channels in a neural network where the number of channels changes from the input side of the first neural network layer to the output side of the first neural network layer is an integer at the output side of the first neural network layer. For example, for each of the neural network layers of the neural network for it's respective number of input channels Cᵢₙ and respective number of output channels Cₒᵤₜ the condition Cₒᵤₜ=p*Cᵢₙ/q, where Cᵢₙ is a multiple of q, and Cᵢₙ, Cₒᵤₜ, p, and q are (positive) integers, may be fulfilled. Alternatively, the condition is fulfilled for those neural network layers of the neural network for which the number of channels changes from one neural network layer to another neural network layer. Contrary to the art, the number of all channels in a neural network where the number of channels changes from one neural network layer to another neural network layer may be restricted to integer values.

In many applications, such as in the context of video coding, even small arithmetic errors cannot be tolerated. For example, the quality of synthesized video frames obtained based on auto encoders and/or hyper scale decoders, as described in more detail below, can be heavily affected by arithmetic/numerical errors caused by floating point operations, particularly, floating point operations performed on the decoder side on computer hardware architectures that are different from computer hardware architectures used on the encoder side. Restriction of the number of channels in a neural network where the number of channels changes from one neural network layer to another to integers increases precision of the overall coding and avoids the conventional need for performing rounding processes for fractional channels which conventionally cause data/information loss.

The features described with reference to the following implementations may be combined as considered suitable.

According to an implementation, the neural network further comprises a third neural network layer and the second neural network layer is further configured to output a third number of channels C′ and the third neural network layer is configured to obtain (receive) the third number of channels C′, wherein C′=p′*Cₒᵤₜ/q′, Cₒᵤₜ is a multiple of q′ and C′, p′ and q′ are (positive) integers. For example, p′/q′=2 or p′/q′=5/2. A similar condition may hold for the output channels of the third neural network layer. The third number of channels C′ may be different from the first number of channels Cᵢₙ and/or the second number of channels Cₒᵤₜ. The condition C′=p′*Cₒᵤₜ/q′ advantageously guarantees that for both the first neural network layer and the second neural network layer the number of input and output channels is an integer.

Different additional conditions may also be fulfilled when the neural network comprises the first, second, and third neural network layers. According to an implementation, the third number of channels is smaller than the second number of channels, and the second number of channels is smaller than the first number of channels. Thereby, a continuous reduction of tensor sizes can be achieved while keeping numbers of channels integer-valued. According to another implementation, the third number of channels is smaller than the second number of channels, and the second number of channels is larger than the first number of channels. Thereby, an increase of tensor sizes (for example, for temporal hypothesis storage) followed by a reduction of tensor sizes (for example, after input data is utilized for hypothesis selection) is achieved while keeping numbers of channels integer-valued. According to another implementation, the third number of channels is larger than the second number of channels, and the second number of channels is larger than the first number of channels. Thereby, a continuous increase of tensor sizes can be achieved while keeping numbers of channels integer-valued.

According to another implementation, the neural network does not allow that the third number of channels is larger than the second number of channels and the second number of channels is smaller than the first number of channels. In other words in the neural network according to the first aspect and implementations thereof it does not hold that both the third number of channels is larger than the second number of channels, and the second number of channels is smaller than the first number of channels. Thereby, loss of data followed by (inaccurate) re-creation of data can be prevented.

According to another implementation, the first number of channels Cᵢₙ and the second number of channels Cₒᵤₜ are multiples of a chunk size. The same may hold for the third number of channels C′. Moreover, the numbers of all channels of the neural network may be multiples of a chunk size. For example, the chunk size is 16 or 32. The first number of channels Cᵢₙ and/or the second number of channels Cₒᵤₜ and/or the third number of channels C′ and/or the numbers of all channels of the neural network may be multiples of 16 or 32, in general. The chunk size defines the number of output channels that can be processed in parallel by the involved computational means. An entire number of output channels can be split into chunks for parallel processing where each chunk has the chunk size. Providing numbers of channels as multiples of the chunk size may further increase the speed of the calculations involved, for example, calculations involved in video coding processes. Providing numbers of channels as multiples of 16 or 32 may, in general, increases the speed of the calculations involved, for example, calculations involved in video coding processes.

As already mentioned the neural network according to the first aspect and the implementations thereof can, advantageously, be applied for video coding purposes. According to an implementation, the first neural network layer or a sub-net of the neural network is a hyper scale decoder sub-net. According to another implementation, the first neural network layer or a sub-net of the neural network is a prediction fusion sub-net. However, the features of the present disclosure are not limited to the first neural network layer or a sub-net of the neural network being a hyper scale decoder sub-net or prediction fusion sub-net.

The present disclosure may use the following hierarchy of terms: a neural network comprises a (neural network) sub-net, also called net, and a (neural network) sub-net comprises one or more neural network layer; and a sub-net may comprise one or more other sub-nets. The term neural network layer may be used for a neural network sub-net.

According to a further implementation, the first neural network layer comprises data paths (corresponding to the first number of channels Cᵢₙ) for at least one of a primary component and a secondary component. The primary component may be one of the RGB or YUV color components and the secondary component may be another one of the RGB or YUV color components. Coding of the secondary component may be based on the primary component and tensor sizes involved in processing of the secondary component may be smaller than tensor sizes involved in processing of the primary component.

According to another implementation of the neural network according to the first aspect, the neural network comprises at least one neural network sub-net consisting of consecutive neural network layers and for the at least one neural network sub-net at least one of the following conditions is fulfilled for consecutive neural network layers for which the number of channels changes from one neural network layer to another:
a) each of the consecutive neural network layers is configured to output only a number of channels that is smaller or larger than a number of channels it receives from a previous one of the consecutive neural network layers in processing order;
b) the consecutive neural network layers consist of a first sub-set of consecutive neural network layers followed in processing order by a second sub-set of consecutive neural network layers; and
   i) each of the consecutive neural network layers of the first sub-set is configured to output only a number of channels that is larger than a number of channels it receives from a previous one of the consecutive neural network layers of the first sub-set in processing order; and
   ii) each of the consecutive neural network layers of the second sub-set is configured to output only a number of channels that is smaller than a number of channels it receives from a previous one of the consecutive neural network layers of the second sub-set in processing order;
and
c) the consecutive neural network layers consist of a first sub-set of consecutive neural network layers followed in processing order by a second sub-set of consecutive neural network layers; and
   i) each of the consecutive neural network layers of the first sub-set is configured to output only a number of channels that is smaller than a number of channels it receives from a previous one of the consecutive neural network layers of the first sub-set in processing order;
   ii) none of the consecutive neural network layers of the second sub-set is configured to output a number of channels that is larger than a number of channels it receives from a previous one of the consecutive neural network layers of the second sub-set in processing order; and
   iii) a first one of the consecutive neural network layers of the second sub-set in processing order is configured to only output a number of channels that is smaller than a number of channels it receives from a last one of the consecutive neural network layers of the first sub-set in processing order.

Thereby, the additional conditions of the above-described implantations are further developed.

According to a further implementation, each of the consecutive neural network layers is configured to output a number of channels that is a multiple of 16 or 32.

According to a further implementation, the at least one neural network sub-net is one of a hyper scale decoder sub-net and a prediction fusion sub-net.

According to a second aspect, it is provided a method (computer-implemented method) of operating a neural network with a variable number of channels of neural network layers. The method of operating a neural network according to the second aspect and implementations thereof as described in the following can be implemented in the neural network according to the first aspect and the implementations thereof. Further, the neural network according to the first aspect and the implementations thereof may be used by the method according to the second aspect. The method according to the second aspect and implementations thereof provide similar advantages as described above.

The method of operating a neural network with a variable number of channels of neural network layers according to the second aspect comprises the steps of: obtaining (receiving) by a first neural network layer a first number of channels Cᵢₙ as input, outputing by the first neural network layer a second number of channels Cₒᵤₜ, where the first number of channels is different from the second number of channels, Cₒᵤₜ=p*Cᵢₙ/q, Cᵢₙ is a multiple of q, and Cᵢₙ, Cₒᵤₜ, p and q are (positive) integers, and obtaining (receiving) by a second neural network layer the second number of channels Cₒᵤₜ as input. The integer q may equal to 2. For example, p/q=5/2 or p/q=2.

According to an implementation, the method according to the second aspect further comprises outputting by the second neural network layer a third number of channels C′ and obtaining (receiving) by a third neural network layer the third number of channels C′, wherein C′=p′*Cₒᵤₜ/q′, Cₒᵤₜ is a multiple of q′, and C′, p′ and q′ are (positive) integers. For example, p′/q′=2 or p′/q′=5/2.

According to another implementation, one of the following conditions is fulfilled: the third number of channels is smaller than the second number of channels, and the second number of channels is smaller than the first number of channels, or the third number of channels is smaller than the second number of channels, and the second number of channels is larger than the first number of channels, or the third number of channels is larger than the second number of channels, and the second number of channels is larger than the first number of channels.

According to another implementation, it does not hold that both the third number of channels is larger than the second number of channels and the second number of channels is smaller than the first number of channels.

According to another implementation, the first number of channels Cᵢₙ and the second number of channels Cₒᵤₜ are multiples of a chunk size. The chunk size may be 16 or 32.

According to another implementation, the first neural network layer or a sub-net of the neural network is a hyper scale decoder net.

According to another implementation, the first neural network layer or a sub-net of the neural network is a prediction fusion net.

According to another implementation, the first neural network layer comprises data paths for a primary component or/and a secondary component.

According to another implementation, the neural network comprises at least one neural network sub-net consisting of consecutive neural network layers and for the at least one neural network sub-net at least one of the following conditions is fulfilled for consecutive neural network layers for which the number of channels changes from one neural network layer to another:
a) each of the consecutive neural network layers outputs only a number of channels that is smaller or larger than a number of channels it receives from a previous one of the consecutive neural network layers in processing order;
b) the consecutive neural network layers consist of a first sub-set of consecutive neural network layers followed in processing order by a second sub-set of consecutive neural network layers; and
   i) each of the consecutive neural network layers of the first sub-set outputs only a number of channels that is larger than a number of channels it receives from a previous one of the consecutive neural network layers of the first sub-set in processing order; and
   ii) each of the consecutive neural network layers of the second sub-set outputs only a number of channels that is smaller than a number of channels it receives from a previous one of the consecutive neural network layers of the second sub-set in processing order;
and
c) the consecutive neural network layers consist of a first sub-set of consecutive neural network layers followed in processing order by a second sub-set of consecutive neural network layers; and
   i) each of the consecutive neural network layers of the first sub-set outputs only a number of channels that is smaller than a number of channels it receives from a previous one of the consecutive neural network layers of the first sub-set in processing order;
   ii) none of the consecutive neural network layers of the second sub-set outputs a number of channels that is larger than a number of channels it receives from a previous one of the consecutive neural network layers of the second sub-set in processing order; and
   iii) a first one of the consecutive neural network layers of the second sub-set in processing order only outputs a number of channels that is smaller than a number of channels it receives from a last one of the consecutive neural network layers of the first sub-set in processing order.

According to another implementation, the method comprises outputting by each of the consecutive neural network layers a number of channels that is a multiple of 16 or 32.

According to another implementation, the at least one neural network sub-net is one of a hyper scale decoder sub-net and a prediction fusion sub-net.

Furthermore, the present disclosure describes a method of encoding data, comprising the steps of the method of operating a neural network according to the second aspect or any implementation thereof.

Furthermore, the present disclosure describes a method of decoding encoded data, comprising the steps of the method of operating a neural network according to the second aspect or any implementation thereof.

Furthermore, the present disclosure describes a computer program product comprising a program code stored on a non-transitory medium, wherein the program, when executed on one or more processors, performs the method of operating a neural network according to the second aspect or any implementation thereof.

Furthermore, the present disclosure describes an apparatus for encoding data, wherein the apparatus comprises processing circuitry configured for performing the steps of the method of operating a neural network according to the second aspect or any implementation thereof.

Furthermore, the present disclosure describes an apparatus for decoding data, wherein the apparatus comprises processing circuitry configured for performing the steps of the method of operating a neural network according to the second aspect or any implementation thereof.

Furthermore, the present disclosure describes an apparatus for decoding at least a portion of an encoded image, comprising processing circuitry configured for providing an entropy model comprising performing the steps of the method of operating a neural network according to the second aspect or any implementation thereof, processing a bitstream by means of a neural network based on the provided entropy model to obtain a latent tensor representing a component of the image, and processing the latent tensor to obtain a tensor representing the component of the image.

Furthermore, the present disclosure describes an apparatus for encoding at least a portion of an image, comprising the neural network according to the first aspect or any implementation thereof.

Furthermore, the present disclosure describes an apparatus for decoding at least a

portion of an encoded image, comprising the neural network according to the first aspect or any implementation thereof.

### BRIEF DESCRIPTION OF THE DRAWINGS

In the following embodiments of the present disclosure are described in more detail with reference to the attached figures and drawings, in which

FIG. 1 is a schematic drawing illustrating channels processed by layers of a neural network;

FIG. 2 is a schematic drawing illustrating an autoencoder type of a neural network;

FIG. 3A is a schematic drawing illustrating an exemplary network architecture for encoder and decoder side including a hyperprior model;

FIG. 3B is a schematic drawing illustrating a general network architecture for encoder side including a hyperprior model;

FIG. 3C is a schematic drawing illustrating a general network architecture for decoder side including a hyperprior model;

FIG. 4 is a schematic drawing illustrating an exemplary network architecture for encoder and decoder side including a hyperprior model;

FIG. 5 is a block diagram illustrating a structure of a cloud-based solution for machine based tasks such as machine vision tasks;

FIG. 6A is a block diagram illustrating end-to-end video compression framework based on a neural networks;

FIG. 6B is a block diagram illustrating some exemplary details of application of a neural network for motion field compression;

FIG. 6C is a block diagram illustrating some exemplary details of application of a neural network for motion compensation;

FIG. 7A is an example illustrating AI learnable image codec architecture;

FIG. 7B illustration of convolution and inverse convolution with variable number of channels (e.g. several examples for Cᵢₙ>Cₒᵤₜ and Cᵢₙ<Cₒᵤₜ);

FIG. 8 depicts block diagrams illustrating exemplary encoder-side sub-networks;

FIG. 9a depicts block diagrams illustrating exemplary decoder-side sub-networks, comprising a hyper scale decoder sub-net and a prediction fusion sub-net;

FIG. 9b is block diagram illustrating an alternative architecture for a hyper scale decoder sub-net as compared to the one illustrated in FIG. 9a.

FIG. 9c is block diagram illustrating an alternative architecture for a prediction fusion sub-net as compared to the one illustrated in FIG. 9a.

FIG. 10 depicts some exemplary and commonly used NN elements;

FIG. 11 depicts an exemplary implementation of an embodiment of the present disclosure compared with a conventional method;

FIG. 12 depicts an exemplary implementation of an embodiment of the present disclosure compared with a conventional method;

FIG. 13 is a block diagram illustrating an example of an encoding apparatus or a decoding apparatus;

FIG. 14 is a block diagram illustrating another example of an encoding apparatus or a decoding apparatus;

FIG. 15 is a block diagram showing an example of a video coding system configured to implement embodiments of the present disclosure;

FIG. 16 is a block diagram showing another example of a video coding system configured to implement embodiments of the present disclosure;

FIG. 17 is a block diagram illustrating an example of an encoding apparatus or a decoding apparatus;

FIG. 18 is a block diagram illustrating another example of an encoding apparatus or a decoding apparatus;

FIG. 19 is a block diagram illustrating another example of an encoding apparatus or a decoding apparatus.

FIG. 20 is a block diagram illustrating a neural network comprising a first neural network layer and a second neural network layer according to an embodiment of the present disclosure.

FIG. 21 is a flow chart illustrating a method of operating a neural network with a variable number of channels of neural network layers according to an embodiment of the present disclosure.

Like reference numbers and designations in different drawings may indicate similar elements.

### DETAILED DESCRIPTION

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

In the following, an overview over some of the used technical terms and framework within which the embodiments of the present disclosure may be employed is provided.

### Artificial Neural Networks

Artificial neural networks (ANNs) or connectionist systems are computing systems vaguely inspired by the biological neural networks that constitute animal brains. Such systems “learn” to perform tasks by considering examples, generally without being programmed with task-specific rules. For example, in image recognition, they might learn to identify images that contain cats by analyzing example images that have been manually labeled as “cat” or “no cat” and using the results to identify cats in other images. They do this without any prior knowledge of cats, for example, that they have fur, tails, whiskers and cat-like faces. Instead, they automatically generate identifying characteristics from the examples that they process.

An ANN is based on a collection of connected units or nodes called artificial neurons, which loosely model the neurons in a biological brain. Each connection, like the synapses in a biological brain, can transmit a signal to other neurons. An artificial neuron that receives a signal then processes it and can signal neurons connected to it.

In ANN implementations, the “signal” at a connection is a real number, and the output of each neuron is computed by some non-linear function of the sum of its inputs. The connections are called edges. Neurons and edges typically have a weight that adjusts as learning proceeds. The weight increases or decreases the strength of the signal at a connection. Neurons may have a threshold such that a signal is sent only if the aggregate signal crosses that threshold. Typically, neurons are aggregated into layers. Different layers may perform different transformations on their inputs. Signals travel from the first layer (the input layer), to the last layer (the output layer), possibly after traversing the layers multiple times.

The original goal of the ANN approach was to solve problems in the same way that a human brain would. Over time, attention moved to performing specific tasks, leading to deviations from biology. ANNs have been used on a variety of tasks, including computer vision, speech recognition, machine translation, social network filtering, playing board and video games, medical diagnosis, and even in activities that have traditionally been considered as reserved to humans, like painting.

The term “convolutional neural network” (CNN) indicates that the network employs a mathematical operation called convolution. Convolution is a specialized kind of linear operation. Convolutional networks are neural networks that use convolution in place of a general matrix multiplication in at least one of their layers.

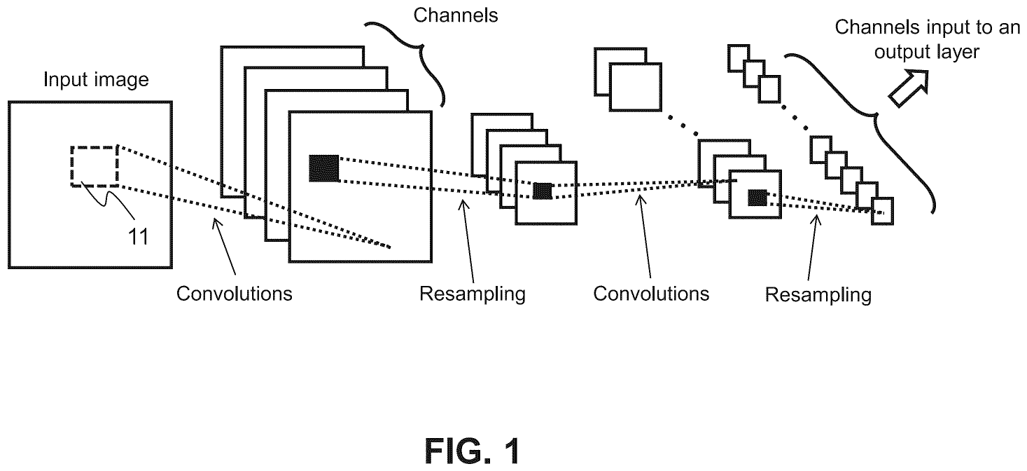

FIG. 1 schematically illustrates a general concept of processing by a neural network such as the CNN. A convolutional neural network consists of an input and an output layer, as well as multiple hidden layers. Input layer is the layer to which the input (such as a portion 11 of an input image as shown in FIG. 1) is provided for processing. The hidden layers of a CNN typically consist of a series of convolutional layers that convolve with a multiplication or other dot product. The result of a layer is one or more feature maps (illustrated by empty solid-line rectangles), sometimes also referred to as channels. There may be a resampling (such as subsampling) involved in some or all of the layers. As a consequence, the feature maps may become smaller, as illustrated in FIG. 1. It is noted that a convolution with a stride may also reduce the size (resample) an input feature map. The activation function in a CNN is a ReLU (Rectified Linear Unit) layer or Leaky ReLU, and is subsequently followed by additional convolutions such as pooling layers, fully connected layers and normalization layers, referred to as hidden layers because their inputs and outputs are masked by the activation function and final convolution. Though the layers are colloquially referred to as convolutions, this is only by convention. Mathematically, it is technically a sliding dot product or cross-correlation. This has significance for the indices in the matrix, in that it affects how the weight is determined at a specific index point.

When programming a CNN for processing images, as shown in FIG. 1, the input is a tensor with shape (number of images)×(image width)×(image height)×(image depth). It should be known that the image depth can be constituted by channels of an image. After passing through a convolutional layer, the image becomes abstracted to a feature map, with shape (number of images)×(feature map width)×(feature map height)×(feature map channels). A convolutional layer within a neural network should have the following attributes. Convolutional kernels defined by a width and height (hyper-parameters). The number of input channels and output channels (hyper-parameter). The depth of the convolution filter (the input channels) should be equal to the number channels (depth) of the input feature map.

In the past, traditional multilayer perceptron (MLP) models have been used for image recognition. However, due to the full connectivity between nodes, they suffered from high dimensionality, and did not scale well with higher resolution images. A 1000×1000-pixel image with RGB color channels has 3 million weights, which is too high to feasibly process efficiently at scale with full connectivity. Also, such network architecture does not take into account the spatial structure of data, treating input pixels which are far apart in the same way as pixels that are close together. This ignores locality of reference in image data, both computationally and semantically. Thus, full connectivity of neurons is wasteful for purposes such as image recognition that are dominated by spatially local input patterns.

Convolutional neural networks are biologically inspired variants of multilayer perceptrons that are specifically designed to emulate the behavior of a visual cortex. These models mitigate the challenges posed by the MLP architecture by exploiting the strong spatially local correlation present in natural images. The convolutional layer is the core building block of a CNN. The layer's parameters consist of a set of learnable filters (the above-mentioned kernels), which have a small receptive field, but extend through the full depth of the input volume. During the forward pass, each filter is convolved across the width and height of the input volume, computing the dot product between the entries of the filter and the input and producing a 2-dimensional activation map of that filter. As a result, the network learns filters that activate when it detects some specific type of feature at some spatial position in the input.

Stacking the activation maps for all filters along the depth dimension forms the full output volume of the convolution layer. Every entry in the output volume can thus also be interpreted as an output of a neuron that looks at a small region in the input and shares parameters with neurons in the same activation map. A feature map, or activation map, is the output activations for a given filter. Feature map and activation has same meaning. In some papers it is called an activation map because it is a mapping that corresponds to the activation of different parts of the image, and also a feature map because it is also a mapping of where a certain kind of feature is found in the image. A high activation means that a certain feature was found.

Another important concept of CNNs is pooling, which is a form of non-linear down-sampling. There are several non-linear functions to implement pooling among which max pooling is the most common. It partitions the input image into a set of non-overlapping rectangles and, for each such sub-region, outputs the maximum.

Intuitively, the exact location of a feature is less important than its rough location relative to other features. This is the idea behind the use of pooling in convolutional neural networks. The pooling layer serves to progressively reduce the spatial size of the representation, to reduce the number of parameters, memory footprint and amount of computation in the network, and hence to also control overfitting. It is common to periodically insert a pooling layer between successive convolutional layers in a CNN architecture. The pooling operation provides another form of translation invariance.

The pooling layer operates independently on every depth slice of the input and resizes it spatially. The most common form is a pooling layer with filters of size 2×2 applied with a stride of 2 at every depth slice in the input by 2 along both width and height, discarding 75% of the activations. In this case, every max operation is over 4 numbers. The depth dimension remains unchanged. In addition to max pooling, pooling units can use other functions, such as average pooling or l2-norm pooling. Average pooling was often used historically but has recently fallen out of favor compared to max pooling, which often performs better in practice. Due to the aggressive reduction in the size of the representation, there is a recent trend towards using smaller filters or discarding pooling layers altogether. “Region of Interest” pooling (also known as ROI pooling) is a variant of max pooling, in which output size is fixed and input rectangle is a parameter. Pooling is an important component of convolutional neural networks for object detection based on Fast R-CNN architecture.

The above-mentioned ReLU is the abbreviation of rectified linear unit, which applies the non-saturating activation function. It effectively removes negative values from an activation map by setting them to zero. It increases the nonlinear properties of the decision function and of the overall network without affecting the receptive fields of the convolution layer. Other functions are also used to increase nonlinearity, for example the saturating hyperbolic tangent and the sigmoid function. ReLU is often preferred to other functions because it trains the neural network several times faster without a significant penalty to generalization accuracy.

Leaky Rectified Linear Unit, or Leaky ReLU, is a type of activation function based on a ReLU, but it has a small slope for negative values instead of a flat slope. The slope coefficient is determined before training, i.e. it is not learnt during training. This type of activation function is popular in tasks where it suffers from sparse gradients, for example training generative adversarial networks. Leaky ReLU applies the element-wise function:

$$LeakyReLU ( x ) = max ( 0 , x ) + negative\_slope * min ( 0 , x ) , or$$

$$LeakyReLU ( x ) = \{ \begin{matrix}x , & if x \geq 0 \\ negative\_slope * x , & otherwise\end{matrix}$$

Among them, parameters:
negative_slope—Controls the angle of the negative slope. Default: 1e-2
inplace—can optionally do the operation in-place. Default: False.

After several convolutional and max pooling layers, the high-level reasoning in the neural network is done via fully connected layers. Neurons in a fully connected layer have connections to all activations in the previous layer, as seen in regular (non-convolutional) artificial neural networks. Their activations can thus be computed as an affine transformation, with matrix multiplication followed by a bias offset (vector addition of a learned or fixed bias term).

The “loss layer” (including calculating of a loss function) specifies how training penalizes the deviation between the predicted (output) and true labels and is normally the final layer of a neural network. Various loss functions appropriate for different tasks may be used. Softmax loss is used for predicting a single class of K mutually exclusive classes. Sigmoid cross-entropy loss is used for predicting K independent probability values in [0, 1]. Euclidean loss is used for regressing to real-valued labels.

In summary, FIG. 1 shows the data flow in a typical convolutional neural network. First, the input image is passed through convolutional layers and becomes abstracted to a feature map comprising several channels, corresponding to a number of filters in a set of learnable filters of this layer. Then, the feature map is subsampled using e.g. a pooling layer, which reduces the dimension of each channel in the feature map. Next, the data comes to another convolutional layer, which may have different numbers of output channels. As was mentioned above, the number of input channels and output channels are hyper-parameters of the layer. To establish connectivity of the network, those parameters need to be synchronized between two connected layers, such that the number of input channels for the current layers should be equal to the number of output channels of the previous layer. For the first layer which processes input data, e.g. an image, the number of input channels is normally equal to the number of channels of data representation, for instance 3 channels for RGB or YUV representation of images or video, or 1 channel for grayscale image or video representation. The channels obtained by one or more convolutional layers (and possibly resampling layer(s)) may be passed to an output layer. Such output layer may be a convolutional or resampling in some implementations. In an exemplary and non-limiting implementation, the output layer is a fully connected layer.

### Autoencoders and Unsupervised Learning

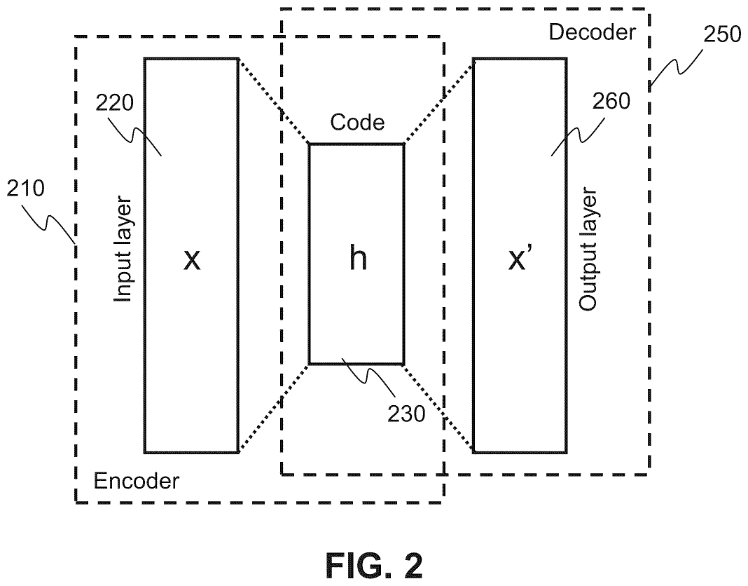

An autoencoder is a type of artificial neural network used to learn efficient data codings in an unsupervised manner. A schematic drawing thereof is shown in FIG. 2. The autoencoder includes an encoder side 210 with an input x inputted into an input layer of an encoder subnetwork 220 and a decoder side 250 with output x′ outputted from a decoder subnetwork 260. The aim of an autoencoder is to learn a representation (encoding) 230 for a set of data x, typically for dimensionality reduction, by training the network 220, 260 to ignore signal “noise”. Along with the reduction (encoder) side subnetwork 220, a reconstructing (decoder) side subnetwork 260 is learnt, where the autoencoder tries to generate from the reduced encoding 230 a representation x′ as close as possible to its original input x, hence its name. In the simplest case, given one hidden layer, the encoder stage of an autoencoder takes the input x and maps it to h

$$h = σ ( Wx + b ) .$$

This image h is usually referred to as code 230, latent variables, or latent representation. Here, σ is an element-wise activation function such as a sigmoid function or a rectified linear unit. W is a weight matrix b is a bias vector. Weights and biases are usually initialized randomly, and then updated iteratively during training through Backpropagation. After that, the decoder stage of the autoencoder maps h to the reconstruction x′of the same shape as x:

$${x}^{′} = {σ}^{′} ( {W}^{′} {h}^{′} + {b}^{′} )$$

where σ′, W′ and b′ for the decoder may be unrelated to the corresponding σ, W and b for the encoder.

Variational autoencoder models make strong assumptions concerning the distribution of latent variables. They use a variational approach for latent representation learning, which results in an additional loss component and a specific estimator for the training algorithm called the Stochastic Gradient Variational Bayes (SGVB) estimator. It assumes that the data is generated by a directed graphical model p_{θ}(x|h) and that the encoder is learning an approximation q_{ϕ}(h|x) to the posterior distribution p_{θ}(h|x) where ϕ and θ denote the parameters of the encoder (recognition model) and decoder (generative model) respectively. The probability distribution of the latent vector of a VAE typically matches that of the training data much closer than a standard autoencoder. The objective of VAE has the following form:

$$ℒ ( ϕ , θ , x ) = {D}_{KL} ( {q}_{ϕ} ( h \vert x ) ‖ {p}_{θ} ( h ) ) - {E}_{{q}_{ϕ} ( h \vert x )} ( log {p}_{θ} ( x \vert h ) )$$

Here, D_{KL} stands for the Kullback-Leibler divergence. The prior over the latent variables is usually set to be the centered isotropic multivariate Gaussian p_{θ}(h)= [symbol] (0, I). Commonly, the shape of the variational and the likelihood distributions are chosen such that they are factorized Gaussians:

$${q}_{ϕ} ( h \vert x ) = 𝒩 ( ρ ( x ) , {ω}^{2} ( x ) I )$$

$${p}_{ϕ} ( x \vert h ) = 𝒩 ( μ ( h ) , {σ}^{2} ( h ) I )$$

where ρ(x) and ω²(x) are the encoder output, while μ(h) and σ²(h) are the decoder outputs.

Recent progress in artificial neural networks area and especially in convolutional neural networks enables researchers' interest of applying neural networks based technologies to the task of image and video compression. For example, End-to-end Optimized Image Compression has been proposed, which uses a network based on a variational autoencoder.

Accordingly, data compression is considered as a fundamental and well-studied problem in engineering, and is commonly formulated with the goal of designing codes for a given discrete data ensemble with minimal entropy. The solution relies heavily on knowledge of the probabilistic structure of the data, and thus the problem is closely related to probabilistic source modeling. However, since all practical codes must have finite entropy, continuous-valued data (such as vectors of image pixel intensities) must be quantized to a finite set of discrete values, which introduces an error.

In this context, known as the lossy compression problem, one must trade off two competing costs: the entropy of the discretized representation (rate) and the error arising from the quantization (distortion). Different compression applications, such as data storage or transmission over limited-capacity channels, demand different rate-distortion trade-offs.

Joint optimization of rate and distortion is difficult. Without further constraints, the general problem of optimal quantization in high-dimensional spaces is intractable. For this reason, most existing image compression methods operate by linearly transforming the data vector into a suitable continuous-valued representation, quantizing its elements independently, and then encoding the resulting discrete representation using a lossless entropy code. This scheme is called transform coding due to the central role of the transformation.

For example, JPEG uses a discrete cosine transform on blocks of pixels, and JPEG 2000 uses a multi-scale orthogonal wavelet decomposition. Typically, the three components of transform coding methods—transform, quantizer, and entropy code—are separately optimized (often through manual parameter adjustment). Modern video compression standards like HEVC, VVC and EVC also use transformed representation to code residual signal after prediction. The several transforms are used for that purpose such as discrete cosine and sine transforms (DCT, DST), as well as low frequency non-separable manually optimized transforms (LFNST).

### Variational Image Compression

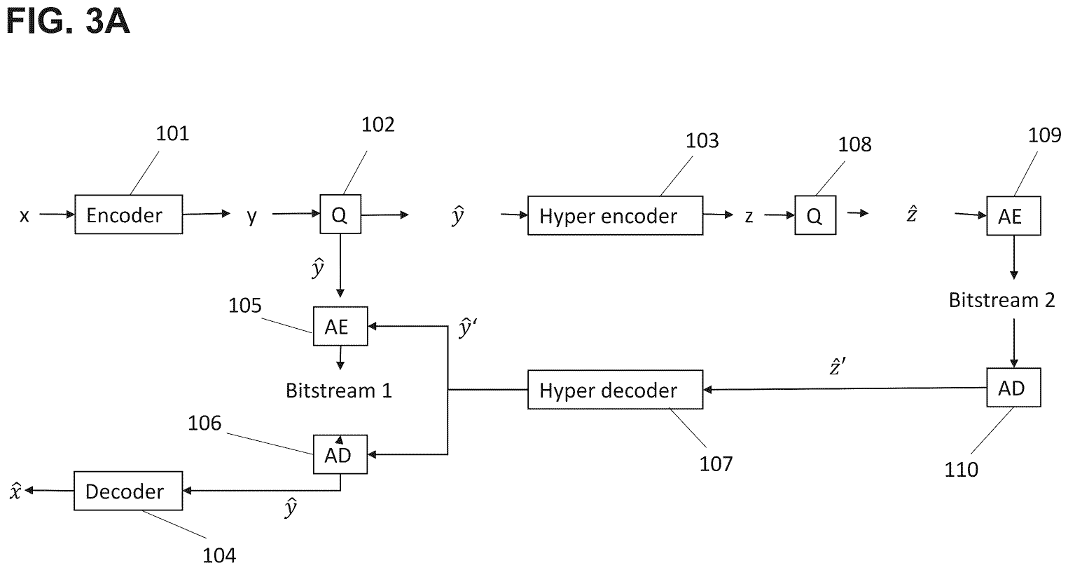

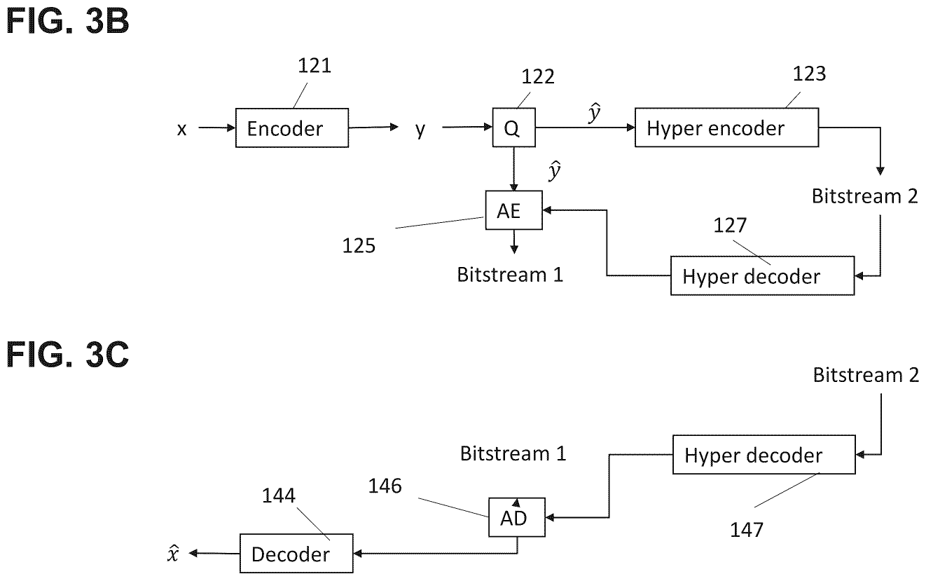

Variable Auto-Encoder (VAE) framework can be considered as a nonlinear transforming coding model. The transforming process can be mainly divided into four parts. This is exemplified in FIG. 3A showing a VAE framework.

The transforming process can be mainly divided into four parts: FIG. 3A exemplifies the VAE framework. In FIG. 3A, the encoder 101 maps an input image x into a latent representation (denoted by y) via the function y=f(x). This latent representation may also be referred to as a part of or a point within a “latent space” in the following. The function f( ) is a transformation function that converts the input signal x into a more compressible representation y. The quantizer 102 transforms the latent representation y into the quantized latent representation ŷ with (discrete) values by ŷ=Q(y), with Q representing the quantizer function. The entropy model, or the hyper encoder/decoder (also known as hyperprior) 103 estimates the distribution of the quantized latent representation ŷ to get the minimum rate achievable with a lossless entropy source coding.

The latent space can be understood as a representation of compressed data in which similar data points are closer together in the latent space. Latent space is useful for learning data features and for finding simpler representations of data for analysis. The quantized latent representation T, ŷ and the side information \hat{z} of the hyperprior 3 are included into a bitstream 2 (are binarized) using arithmetic coding (AE). Furthermore, a decoder 104 is provided that transforms the quantized latent representation to the reconstructed image \hat{x}, \hat{x}=g(ŷ). The signal \hat{x} is the estimation of the input image x. It is desirable that x is as close to \hat{x} as possible, in other words the reconstruction quality is as high as possible. However, the higher the similarity between \hat{x} and x, the higher the amount of side information necessary to be transmitted. The side information includes bitstream1 and bitstream2 shown in FIG. 3A, which are generated by the encoder and transmitted to the decoder. Normally, the higher the amount of side information, the higher the reconstruction quality. However, a high amount of side information means that the compression ratio is low. Therefore, one purpose of the system described in FIG. 3A is to balance the reconstruction quality and the amount of side information conveyed in the bitstream.

In FIG. 3A the component AE 105 is the Arithmetic Encoding module, which converts samples of the quantized latent representation ŷ and the side information \hat{z} into a binary representation bitstream 1. The samples of ŷ and \hat{z} might for example comprise integer or floating point numbers. One purpose of the arithmetic encoding module is to convert (via the process of binarization) the sample values into a string of binary digits (which is then included in the bitstream that may comprise further portions corresponding to the encoded image or further side information).

The arithmetic decoding (AD) 106 is the process of reverting the binarization process, where binary digits are converted back to sample values. The arithmetic decoding is provided by the arithmetic decoding module 106.

It is noted that the present disclosure is not limited to this particular framework. Moreover, the present disclosure is not restricted to image or video compression, and can be applied to object detection, image generation, and recognition systems as well.

In FIG. 3A there are two sub networks concatenated to each other. A subnetwork in this context is a logical division between the parts of the total network. For example, in FIG. 3A the modules 101, 102, 104, 105 and 106 are called the “Encoder/Decoder” subnetwork. The “Encoder/Decoder” subnetwork is responsible for encoding (generating) and decoding (parsing) of the first bitstream “bitstream1”. The second network in FIG. 3A comprises modules 103, 108, 109, 110 and 107 and is called “hyper encoder/decoder” subnetwork. The second subnetwork is responsible for generating the second bitstream “bitstream2”. The purposes of the two subnetworks are different.

The first subnetwork is responsible for:
the transformation 101 of the input image x into its latent representation y (which is easier to compress that x),
quantizing 102 the latent representation y into a quantized latent representation ŷ,
compressing the quantized latent representation ŷ using the AE by the arithmetic encoding module 105 to obtain bitstream “bitstream 1”,
parsing the bitstream 1 via AD using the arithmetic decoding module 106, and
reconstructing 104 the reconstructed image (\hat{x}) using the parsed data.

The purpose of the second subnetwork is to obtain statistical properties (e.g. mean value, variance and correlations between samples of bitstream 1) of the samples of “bitstream1”, such that the compressing of bitstream 1 by first subnetwork is more efficient. The second subnetwork generates a second bitstream “bitstream2”, which comprises the said information (e.g. mean value, variance and correlations between samples of bitstream1).

The second network includes an encoding part which comprises transforming 103 of the quantized latent representation ŷ into side information z, quantizing the side information z into quantized side information \hat{z}, and encoding (e.g. binarizing) 109 the quantized side information \hat{z} into bitstream2. In this example, the binarization is performed by an arithmetic encoding (AE). A decoding part of the second network includes arithmetic decoding (AD) 110, which transforms the input bitstream2 into decoded quantized side information \hat{z}′. The \hat{z}′ might be identical to \hat{z}, since the arithmetic encoding end decoding operations are lossless compression methods. The decoded quantized side information \hat{z}′ is then transformed 107 into decoded side information ŷ′. ŷ′ represents the statistical properties of ŷ (e.g. mean value of samples of ŷ, or the variance of sample values or like). The decoded latent representation ŷ′ is then provided to the above-mentioned Arithmetic Encoder 105 and Arithmetic Decoder 106 to control the probability model of ŷ.

The FIG. 3A describes an example of VAE (variational auto encoder), details of which might be different in different implementations. For example in a specific implementation additional components might be present to more efficiently obtain the statistical properties of the samples of bitstream 1. In one such implementation a context modeler might be present, which targets extracting cross-correlation information of the bitstream 1. The statistical information provided by the second subnetwork might be used by AE (arithmetic encoder) 105 and AD (arithmetic decoder) 106 components.

FIG. 3A depicts the encoder and decoder in a single figure. As is clear to those skilled in the art, the encoder and the decoder may be, and very often are, embedded in mutually different devices.

FIG. 3B depicts the encoder and FIG. 3C depicts the decoder components of the VAE framework in isolation. As input, the encoder receives, according to some embodiments, a picture. The input picture may include one or more channels, such as color channels or other kind of channels, e.g. depth channel or motion information channel, or the like. The output of the encoder (as shown in FIG. 3B) is a bitstream1 and a bitstream2. The bitstream1 is the output of the first sub-network of the encoder and the bitstream2 is the output of the second subnetwork of the encoder.

Similarly, in FIG. 3C, the two bitstreams, bitstream1 and bitstream2, are received as input and \hat{z}, which is the reconstructed (decoded) image, is generated at the output. As indicated above, the VAE can be split into different logical units that perform different actions. This is exemplified in FIGS. 3B and 3C so that FIG. 3B depicts components that participate in the encoding of a signal, like a video and provided encoded information. This encoded information is then received by the decoder components depicted in FIG. 3C for encoding, for example. It is noted that the components of the encoder and decoder denoted with numerals 12x and 14x may correspond in their function to the components referred to above in FIG. 3A and denoted with numerals 10x.

Specifically, as is seen in FIG. 3B, the encoder comprises the encoder 121 that transforms an input x into a signal y which is then provided to the quantizer 322. The quantizer 122 provides information to the arithmetic encoding module 125 and the hyper encoder 123. The hyper encoder 123 provides the bitstream2 already discussed above to the hyper decoder 147 that in turn provides the information to the arithmetic encoding module 105 (125).

The output of the arithmetic encoding module is the bitstream1. The bitstream1 and bitstream2 are the output of the encoding of the signal, which are then provided (transmitted) to the decoding process. Although the unit 101 (121) is called “encoder”, it is also possible to call the complete subnetwork described in FIG. 3B as “encoder”. The process of encoding in general means the unit (module) that converts an input to an encoded (e.g. compressed) output. It can be seen from FIG. 3B, that the unit 121 can be actually considered as a core of the whole subnetwork, since it performs the conversion of the input x into y, which is the compressed version of the x. The compression in the encoder 121 may be achieved, e.g. by applying a neural network, or in general any processing network with one or more layers. In such network, the compression may be performed by cascaded processing including downsampling which reduces size and/or number of channels of the input. Thus, the encoder may be referred to, e.g. as a neural network (NN) based encoder, or the like.

The remaining parts in the figure (quantization unit, hyper encoder, hyper decoder, arithmetic encoder/decoder) are all parts that either improve the efficiency of the encoding process or are responsible for converting the compressed output y into a series of bits (bitstream). Quantization may be provided to further compress the output of the NN encoder 121 by a lossy compression. The AE 125 in combination with the hyper encoder 123 and hyper decoder 127 used to configure the AE 125 may perform the binarization which may further compress the quantized signal by a lossless compression. Therefore, it is also possible to call the whole subnetwork in FIG. 3B an “encoder”.

A majority of Deep Learning (DL) based image/video compression systems reduce dimensionality of the signal before converting the signal into binary digits (bits). In the VAE framework for example, the encoder, which is a non-linear transform, maps the input image x into y, where y has a smaller width and height than x. Since the y has a smaller width and height, hence a smaller size, the (size of the) dimension of the signal is reduced, and, hence, it is easier to compress the signal y. It is noted that in general, the encoder does not necessarily need to reduce the size in both (or in general all) dimensions. Rather, some exemplary implementations may provide an encoder which reduces size only in one (or in general a subset of) dimension.

In J. Balle, L. Valero Laparra, and E. P. Simoncelli (2015). “Density Modeling of Images Using a Generalized Normalization Transformation”, In: arXiv e-prints, Presented at the 4th Int. Conf. for Learning Representations, 2016 (referred to in the following as “Balle”) the authors proposed a framework for end-to-end optimization of an image compression model based on nonlinear transforms. The above noted authors optimize for Mean Squared Error (MSE), but use a more flexible transforms built from cascades of linear convolutions and nonlinearities. Specifically, these authors use a generalized divisive normalization (GDN) joint nonlinearity that is inspired by models of neurons in biological visual systems, and has proven effective in Gaussianizing image densities. This cascaded transformation is followed by uniform scalar quantization (i.e., each element is rounded to the nearest integer), which effectively implements a parametric form of vector quantization on the original image space. The compressed image is reconstructed from these quantized values using an approximate parametric nonlinear inverse transform.

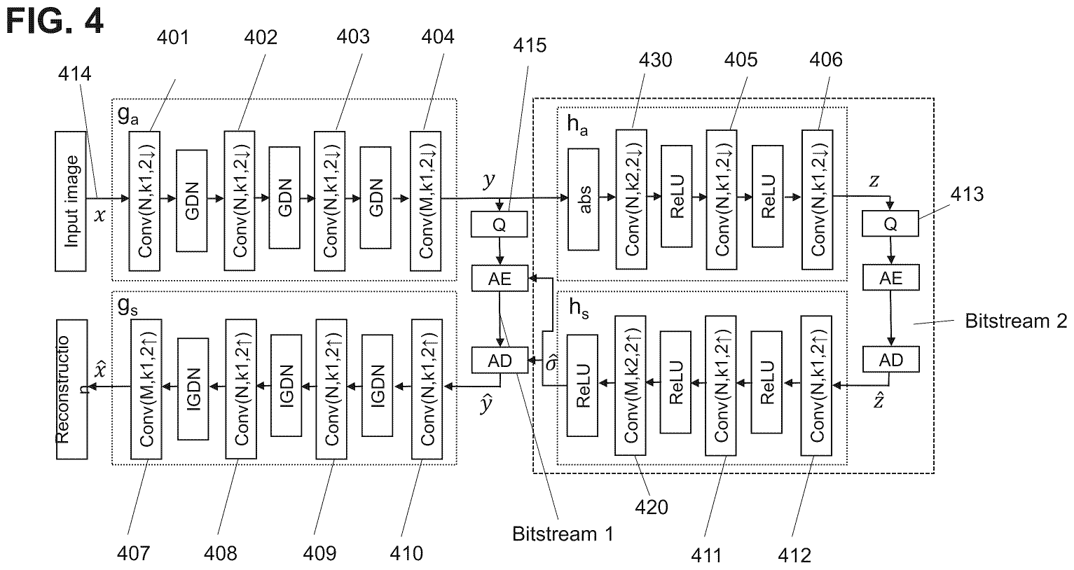

Such an example of the VAE framework is shown in FIG. 4, and it utilizes 6 downsampling layers that are marked with 401 to 406. The network architecture includes a hyperprior model. The left side (gₐ, gₛ) shows an image autoencoder architecture, the right side (hₐ, hₛ) corresponds to the autoencoder implementing the hyperprior. The factorized-prior model uses the identical architecture for the analysis and synthesis transforms gₐ and gₛ. Q represents quantization, and AE, AD represent arithmetic encoder and arithmetic decoder, respectively. The encoder subjects the input image x to gₐ, yielding the responses y (latent representation) with spatially varying standard deviations. The encoding gₐ includes a plurality of convolution layers with subsampling and, as an activation function, generalized divisive normalization (GDN).

The responses are fed into ha, summarizing the distribution of standard deviations in z. z is then quantized, compressed, and transmitted as side information. The encoder then uses the quantized vector \hat{z} to estimate \hat{σ}, the spatial distribution of standard deviations which is used for obtaining probability values (or frequency values) for arithmetic coding (AE), and uses it to compress and transmit the quantized image representation ŷ (or latent representation). The decoder first recovers \hat{z} from the compressed signal. It then uses hₛ to obtain ŷ, which provides it with the correct probability estimates to successfully recover ŷ as well. It then feeds ŷ into gₛ to obtain the reconstructed image.

The layers that include downsampling are indicated with the downward arrow in the layer description. The layer description “Conv N,k1,2↓” means that the layer is a convolution layer, with N channels and the convolution kernel is k1×k1 in size. For example, k1 may be equal to 5 and k2 may be equal to 3. As stated, the 2↓ means that a downsampling with a factor of 2 is performed in this layer. Downsampling by a factor of 2 results in one of the dimensions of the input signal being reduced by half at the output. In FIG. 4, the 2↓ indicates that both width and height of the input image is reduced by a factor of 2. Since there are 6downsampling layers, if the width and height of the input image 414 (also denoted with x) is given by w and h, the output signal z∧413 is has width and height equal to w/64 and h/64 respectively. Modules denoted by AE and AD are the arithmetic encoder and the arithmetic decoder, which are explained with reference to FIGS. 3A to 3C. The arithmetic encoder and decoder are specific implementations of entropy coding. AE and AD can be replaced by other means of entropy coding. In information theory, an entropy encoding is a lossless data compression scheme that is used to convert the values of a symbol into a binary representation which is a revertible process. Also, the “Q” in the figure corresponds to the quantization operation that was also referred to above in relation to FIG. 4 and is further explained above in the section “Quantization”. Also, the quantization operation and a corresponding quantization unit as part of the component 413 or 415 is not necessarily present and/or can be replaced with another unit.

In FIG. 4, there is also shown the decoder comprising upsampling layers 407 to 412. A further layer 420 is provided between the upsampling layers 411 and 410 in the processing order of an input that is implemented as convolutional layer but does not provide an upsampling to the input received. A corresponding convolutional layer 430 is also shown for the decoder. Such layers can be provided in NNs for performing operations on the input that do not alter the size of the input but change specific characteristics. However, it is not necessary that such a layer is provided.

When seen in the processing order of bitstream2 through the decoder, the upsampling layers are run through in reverse order, i.e. from upsampling layer 412 to upsampling layer 407. Each upsampling layer is shown here to provide an upsampling with an upsampling ratio of 2, which is indicated by the ↑. It is, of course, not necessarily the case that all upsampling layers have the same upsampling ratio and also other upsampling ratios like 3, 4, 8 or the like may be used. The layers 407 to 412 are implemented as convolutional layers (conv). Specifically, as they may be intended to provide an operation on the input that is reverse to that of the encoder, the upsampling layers may apply a deconvolution operation to the input received so that its size is increased by a factor corresponding to the upsampling ratio. However, the present disclosure is not generally limited to deconvolution and the upsampling may be performed in any other manner such as by bilinear interpolation between two neighboring samples, or by nearest neighbor sample copying, or the like.

In the first subnetwork, some convolutional layers (401 to 403) are followed by generalized divisive normalization (GDN) at the encoder side and by the inverse GDN (IGDN) at the decoder side. In the second subnetwork, the activation function applied is ReLu. It is noted that the present disclosure is not limited to such implementation and in general, other activation functions may be used instead of GDN or ReLu.

### Cloud Solutions for Machine Tasks

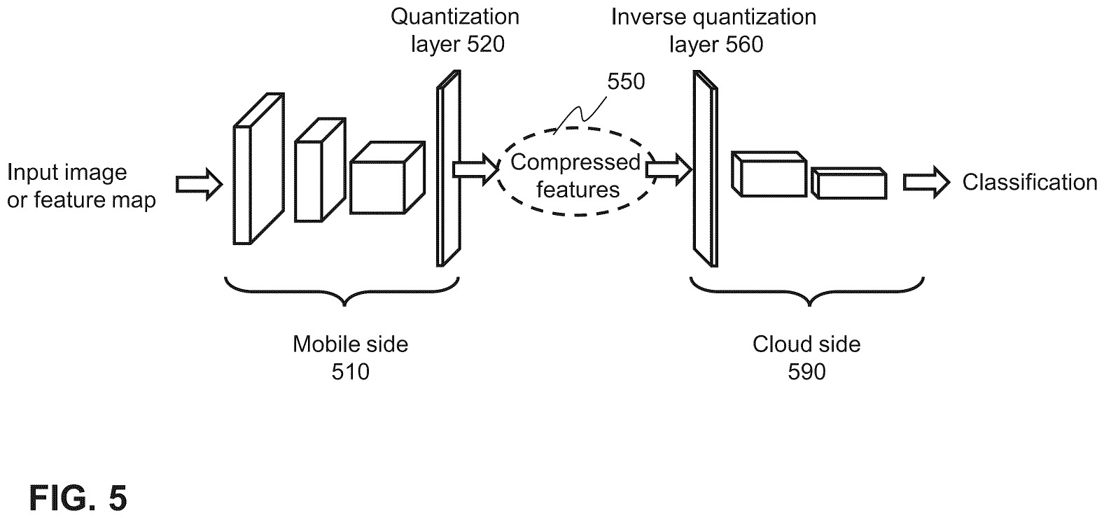

The Video Coding for Machines (VCM) is another computer science direction currently growing in popularity. The main idea behind this approach is to transmit a coded representation of image or video information targeted to further processing by computer vision (CV) algorithms, like object segmentation, detection, and recognition. In contrast to traditional image and video coding targeted to human perception the quality characteristic is the performance of computer vision task, e.g. object detection accuracy, rather than reconstructed quality. This is illustrated in FIG. 5.

Video Coding for Machines is also referred to as collaborative intelligence and it is a relatively new paradigm for efficient deployment of deep neural networks across the mobile-cloud infrastructure. By dividing the network between the mobile side 510 and the cloud side 590 (e.g. a cloud server), it is possible to distribute the computational workload such that the overall energy and/or latency of the system is minimized. In general, the collaborative intelligence is a paradigm where processing of a neural network is distributed between two or more different computation nodes; for example devices, but in general, any functionally defined nodes. Here, the term “node” does not refer to the above-mentioned neural network nodes. Rather the (computation) nodes here refer to (physically or at least logically) separate devices/modules, which implement parts of the neural network. Such devices may be different servers, different end user devices, a mixture of servers and/or user devices and/or cloud and/or processor or the like. In other words, the computation nodes may be considered as nodes belonging to the same neural network and communicating with each other to convey coded data within/for the neural network. For example, in order to be able to perform complex computations, one or more layers may be executed on a first device (such as a device on mobile side 510) and one or more layers may be executed in another device (such as a cloud server on cloud side 590). However, the distribution may also be finer and a single layer may be executed on a plurality of devices. In this disclosure, the term “plurality” refers to two or more. In some existing solution, a part of a neural network functionality is executed in a device (user device or edge device or the like) or a plurality of such devices and then the output (feature map) is passed to a cloud. A cloud is a collection of processing or computing systems that are located outside the device, which is operating the part of the neural network. The notion of collaborative intelligence has been extended to model training as well. In this case, data flows both ways: from the cloud to the mobile during back-propagation in training, and from the mobile to the cloud (illustrated in FIG. 5) during forward passes in training, as well as inference.

Some works presented semantic image compression by encoding deep features and then reconstructing the input image from them. The compression based on uniform quantization was shown, followed by context-based adaptive arithmetic coding (CABAC) from H.264. In some scenarios, it may be more efficient, to transmit from the mobile part 510 to the cloud 590 an output of a hidden layer (a deep feature map) 550, rather than sending compressed natural image data to the cloud and perform the object detection using reconstructed images. It may thus be advantageous to compress the data (features) generated by the mobile side 510, which may include a quantization layer 520 for this purpose. Correspondingly, the cloud side 590 may include an inverse quantization layer 560. The efficient compression of feature maps benefits the image and video compression and reconstruction both for human perception and for machine vision. Entropy coding methods, e.g. arithmetic coding is a popular approach to compression of deep features (i.e. feature maps).

Nowadays, video content contributes to more than 80% internet traffic, and the percentage is expected to increase even further. Therefore, it is critical to build an efficient video compression system and generate higher quality frames at given bandwidth budget. In addition, most video related computer vision tasks such as video object detection or video object tracking are sensitive to the quality of compressed videos, and efficient video compression may bring benefits for other computer vision tasks. Meanwhile, the techniques in video compression are also helpful for action recognition and model compression. However, in the past decades, video compression algorithms rely on hand-crafted modules, e.g., block based motion estimation and Discrete Cosine Transform (DCT), to reduce the redundancies in the video sequences, as mentioned above. Although each module is well designed, the whole compression system is not end-to-end optimized. It is desirable to further improve video compression performance by jointly optimizing the whole compression system.

### End-to-End Image or Video Compression

DNN based image compression methods can exploit large scale end-to-end training and highly non-linear transform, which are not used in the traditional approaches. However, it is non-trivial to directly apply these techniques to build an end-to-end learning system for video compression. First, it remains an open problem to learn how to generate and compress the motion information tailored for video compression. Video compression methods heavily rely on motion information to reduce temporal redundancy in video sequences.

A straightforward solution is to use the learning based optical flow to represent motion information. However, current learning based optical flow approaches aim at generating flow fields as accurate as possible. The precise optical flow is often not optimal for a particular video task. In addition, the data volume of optical flow increases significantly when compared with motion information in the traditional compression systems and directly applying the existing compression approaches to compress optical flow values will significantly increase the number of bits required for storing motion information. Second, it is unclear how to build a DNN based video compression system by minimizing the rate-distortion based objective for both residual and motion information. Rate-distortion optimization (RDO) aims at achieving higher quality of reconstructed frame (i.e., less distortion) when the number of bits (or bit rate) for compression is given. RDO is important for video compression performance. In order to exploit the power of end-to-end training for learning based compression system, the RDO strategy is required to optimize the whole system.

In Guo Lu, Wanli Ouyang, Dong Xu, Xiaoyun Zhang, Chunlei Cai, Zhiyong Gao; “DVC: An End-to-end Deep Video Compression Framework”. Proceedings of the IEEE/CVF Conference on Computer Vision and Pattern Recognition (CVPR), 2019, pp. 11006-11015, the authors proposed the end-to-end deep video compression (DVC) model that jointly learns motion estimation, motion compression, and residual coding.

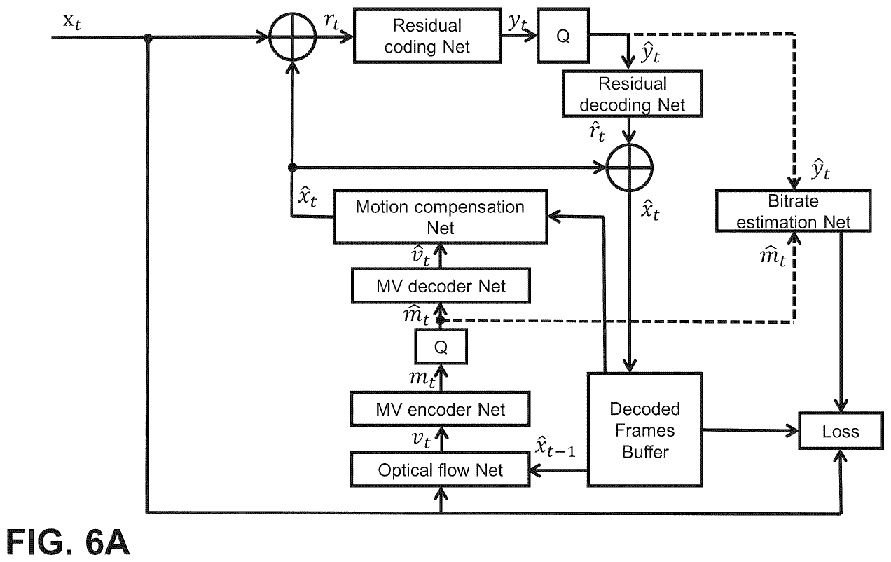

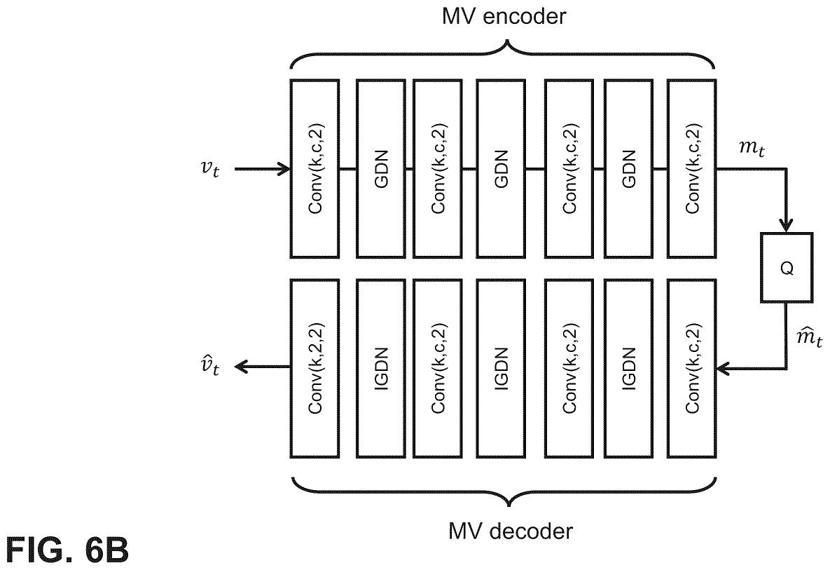

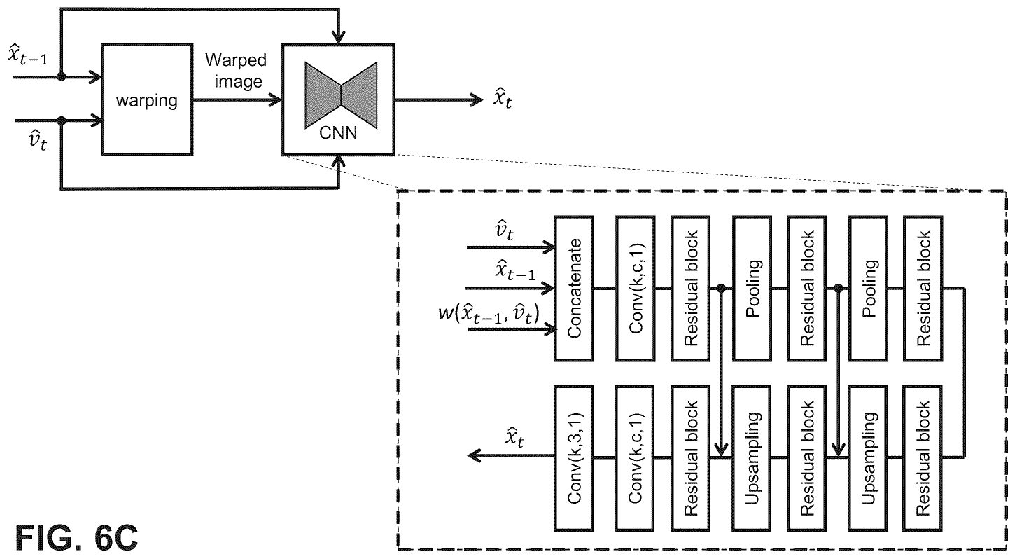

Such an encoder is illustrated in FIG. 6A. In particular, FIG. 6A shows an overall structure of end-to-end trainable video compression framework. In order to compress motion information, a CNN was designated to transform the optical flow vₜ to the corresponding representations mₜ suitable for better compression. Specifically, an auto-encoder style network is used to compress the optical flow. The motion vectors (MV) compression network is shown in FIG. 6B. The network architecture is somewhat similar to the ga/gs of FIG. 4. In particular, the optical flow vₜ is fed into a series of convolution operation and nonlinear transform including GDN and IGDN. The number of output channels c for convolution (deconvolution) is here exemplarily 128 except for the last deconvolution layer, which is equal to 2 in this example. The kernel size is k, e.g. k=3. Given optical flow with the size of M×N×2, the MV encoder will generate the motion representation mₜ with the size of M/16×N/16×128. Then motion representation is quantized (Q), entropy coded and sent to bitstream as \hat{m}ₜ. The MV decoder receives the quantized representation \hat{m}ₜ and reconstruct motion information \hat{v}ₜ using MV encoder. In general, the values for k and c may differ from the above mentioned examples as is known from the art.

FIG. 6C shows a structure of the motion compensation part. Here, using previous reconstructed frame xₜ₋₁ and reconstructed motion information, the warping unit generates the warped frame (normally, with help of interpolation filter such as bi-linear interpolation filter). Then a separate CNN with three inputs generates the predicted picture. The architecture of the motion compensation CNN is also shown in FIG. 6C.

The residual information between the original frame and the predicted frame is encoded by the residual encoder network. A highly non-linear neural network is used to transform the residuals to the corresponding latent representation. Compared with discrete cosine transform in the traditional video compression system, this approach can better exploit the power of non-linear transform and achieve higher compression efficiency.

From above overview it can be seen that CNN based architecture can be applied both for image and video compression, considering different parts of video framework including motion estimation, motion compensation and residual coding. Entropy coding is popular method used for data compression, which is widely adopted by the industry and is also applicable for feature map compression either for human perception or for computer vision tasks.

### Video Coding for Machines

The Video Coding for Machines (VCM) is another computer science direction that is growing in popularity. The main idea behind this approach is to transmit the coded representation of image or video information targeted to further processing by computer vision (CV) algorithms, like object segmentation, detection and recognition. In contrast to traditional image and video coding targeted to human perception the quality characteristic is the performance of computer vision task, e.g. object detection accuracy, rather than reconstructed quality.

A recent study proposed a new deployment paradigm called collaborative intelligence, whereby a deep model is split between the mobile and the cloud. Extensive experiments under various hardware configurations and wireless connectivity modes revealed that the optimal operating point in terms of energy consumption and/or computational latency involves splitting the model, usually at a point deep in the network. Today's common solutions, where the model sits fully in the cloud or fully at the mobile, were found to be rarely (if ever) optimal. The notion of collaborative intelligence has been extended to model training as well. In this case, data flows both ways: from the cloud to the mobile during back-propagation in training, and from the mobile to the cloud during forward passes in training, as well as inference.

Lossy compression of deep feature data has been studied based on HEVC intra coding, in the context of a recent deep model for object detection. It was noted the degradation of detection performance with increased compression levels and proposed compression-augmented training to minimize this loss by producing a model that is more robust to quantization noise in feature values. However, this is still a sub-optimal solution, because the codec employed is highly complex and optimized for natural scene compression rather than deep feature compression.

The problem of deep feature compression for the collaborative intelligence has been addressed by an approach for object detection task using popular YOLOv2 network for the study of compression efficiency and recognition accuracy trade-off. Here the term deep feature has the same meaning as feature map. The word ‘deep’ comes from the collaborative intelligence idea when the output feature map of some hidden (deep) layer is captured and transferred to the cloud to perform inference. That appears to be more efficient rather than sending compressed natural image data to the cloud and perform the object detection using reconstructed images.

The efficient compression of feature maps benefits the image and video compression and reconstruction both for human perception and for machine vision. Disadvantages of state-of-the art autoencoder based approaches to compression are also valid for machine vision tasks.

Quality metrics in JPEG AI common training and test conditions (CTTC) are selected based on their correlation with human perception. Not just a single metric but 7different metrics, sensitive to different types of artifacts are used by JPEG AI. It was noted that the majority of quality metrics are computed in YUV color space, some of them use only the Luminance component. JPEG AI learnable image codec is built under the assumption that one color component contains the most of the information and affects human perception more than other color components. For extracting this strongest color component RGB input goes to the color transform first. The default color transform is RGB→YUV BT.709 (full range). Adaptive color transform with signaling color transform matrix is supported.

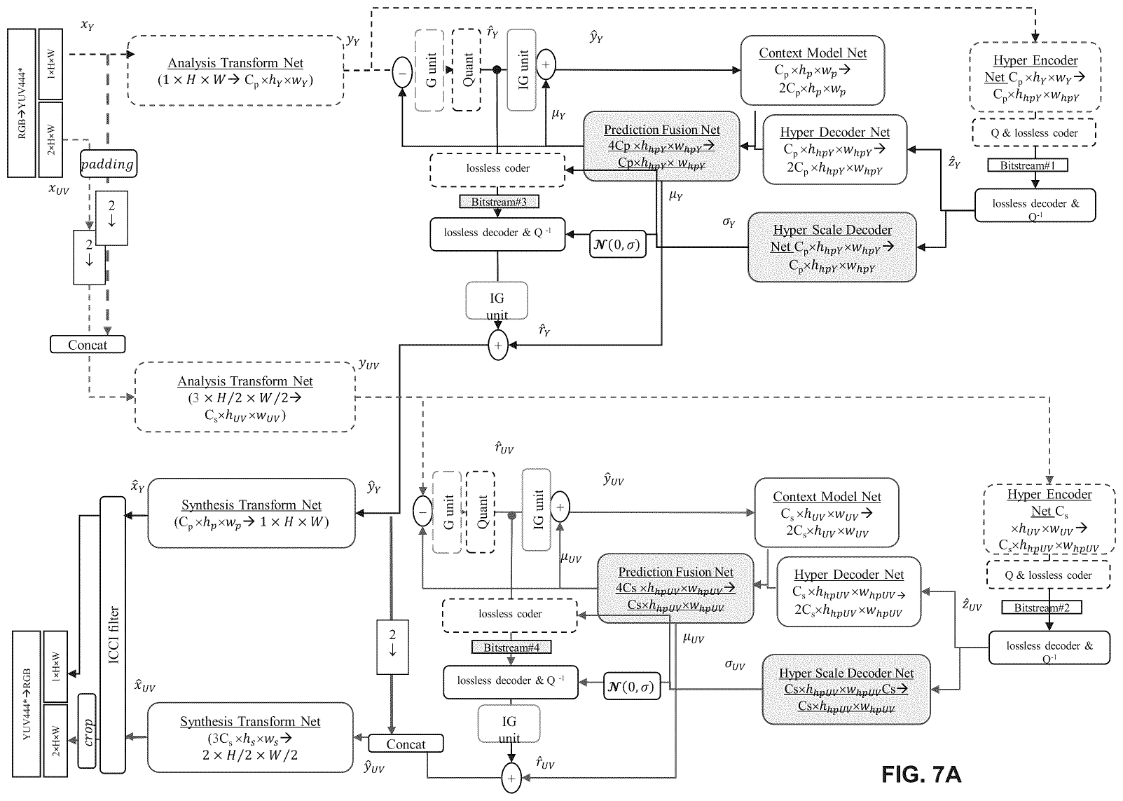

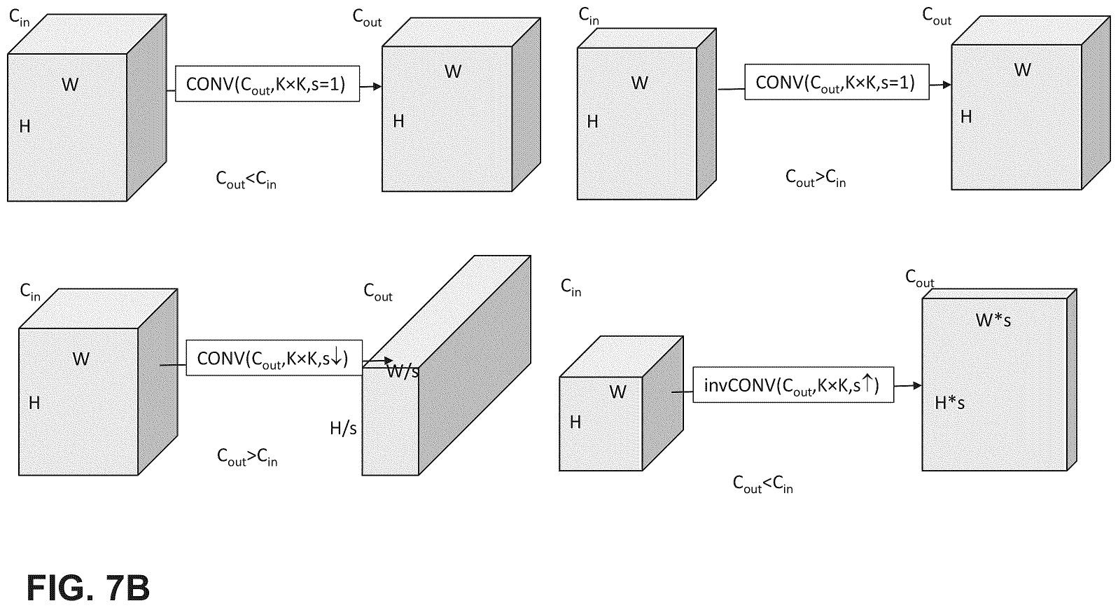

FIG. 7A is an example illustrating AI learnable image codec architecture. Primary and secondary color components are coded separately, using networks with same architecture, but different number of channels. In FIG. 7A, neural sub-networks/data flow which are used on encoder side only are marked by dash-line boxes/lines. Solid line boxes show sub-networks used on decoder (or both on decoder and encoder side). All boxes with same names are sub-networks with same architecture, only input-output tensor size and number of channels are different. Sub-network is also called a Net in this disclosure.

The number of channels of a latent tensor can change from layer to layer inside a neural network. FIG. 7B illustrates several typical cases of convolution and inverse convolution for which a number of channels in input and output tensors are different. Typically, neural network algorithms include equations for a relationship between Cᵢₙ (number of channels for input tensor) and Cₒᵤₜ (number of channels for output tensor), which is often a ratio Cₒᵤₜ=p*Cᵢₙ/q.

In learnable image coding, the input signal to be encoded is notated as x, latent space tensor in bottleneck of variational auto-encoder is y, and hyper-parameters (tensor in the bottleneck of hyper-encoder) is z. Prediction Fusion Net produces prediction μ for latent space tensor y. The residual signal r=y−μ is quantized

$$r {\to }^{Q} \hat{r}$$

and encoded, assuming Gaussian distribution with zero mean value and variance σ which is the output of Hyper Scale Decoder Net.

Input image width and height are W and H, respectively. Primary component and related tensors are marked with “Y” on FIG. 7A. A primary component is coded in full resolution (size of x_{Y} is H×W). The output of Analysis Transform Net (for primary component is Cₚ×h_{Y}×w_{Y}). The number of channels allocated for primary component coding is Cₚ=128. The output of Hyper Encoder Net for primary component is Cₚ×h_{hpY}×w_{hpY}.

Secondary components are coded jointly. Secondary components joint and related tensors are marked with “UV” on FIG. 7A. Secondary components are coded in reduced resolution. So, secondary and primary tensor color components prior to Analysis Transform Net go through down-sampling module. Input of Analysis Transform Net for secondary component is concatenated tensor of three color components in reduced resolution; the size of this tensor is W/2×W/2×3. The output of Analysis Transform Net for secondary component is Cₛ×h_{YUV}×w_{UV}. The number of channels allocated for secondary components coding Cₛ=64. The output of Hyper Encoder Net for secondary components is Cₛ×h_{hpUV}×w_{hpUV}.

Prediction sub-network, for example, Prediction Fusion Net in FIG. 7A, operates independently and has same architecture for primary and secondary components. Prediction sub-network outputs tensor of same size w×h×C as latent space tensor y. Prediction sub-network receives tensor of same spatial size, but with four times larger amount of channels w×h×4C. Half of the channels come as output of Context Model Net, another half is output of Hyper Decoder Net.

Convolutions with down-sampling stride are part of JPEG AI of learnable codec architectures. In order to have tensor size always be the multiple of down-sampling stride before convolution with down-sampling stride the padding layer is inserted.

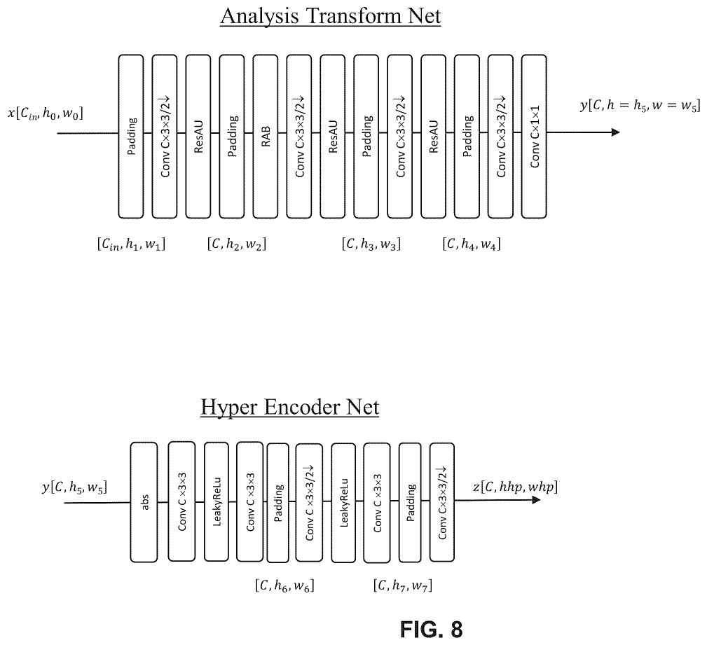

FIG. 8 are block diagrams illustrating exemplary encoder-side sub-networks. For example, the analysis transform net may include a sequence of four convolutions with down-sampling stride 2. Size of the tensor in different parts of analysis transform net is shown in FIG. 8 as an example. As can be seen that peak memory usage occurs after first convolutional layer.

As shown in FIG. 8, each of those convolutions is preceded by a padding layer. Padding layer changes tensor size as follows: hₜ=ceil(hₜ₋₁,s), wₜ=ceil(wₜ₋₁,s); here s is down sampling convolution stride (s=2).

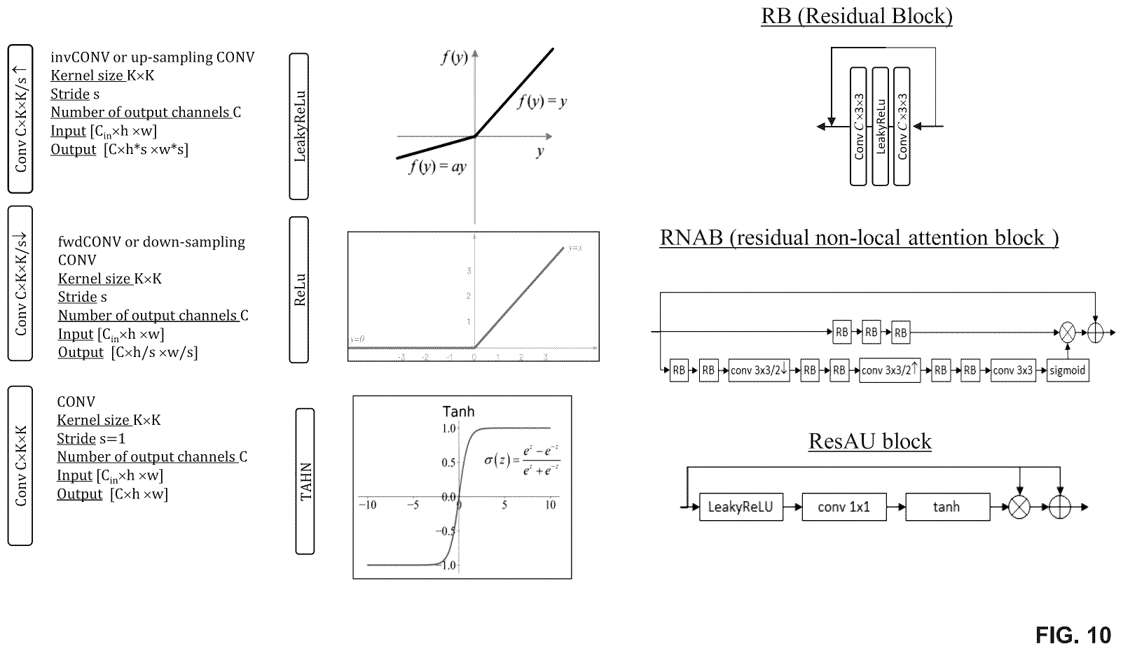

Non-linear activation layers in Analysis transform net are residual nonlinear unit with attention mechanism (ResAU) (For example, ResAU block in FIG. 10). ResAU consists of element-wise nonlinear operations (ReLU), convolution layer, element-wise multiplication operation (tahn) and residual connection. The detailed structure of ResAU used in Analysis transform net (also called as transform module) is depicted in FIG. 10.

One residual non-local attention block (RNAB) is used in the analysis transform net. RNAB is located in between first and second down-sampling convolution and plays the role of attention mechanism. Since RNAB (For example, RNAB in FIG. 10) includes one down- and one up-sampling convolution, a series of Residual Blocks (for example, RB depicted in FIG. 10), the Padding layer is inserted before RNAB. RNAB also includes the series of Residual Blocks (for example, RB depicted in FIG. 10).

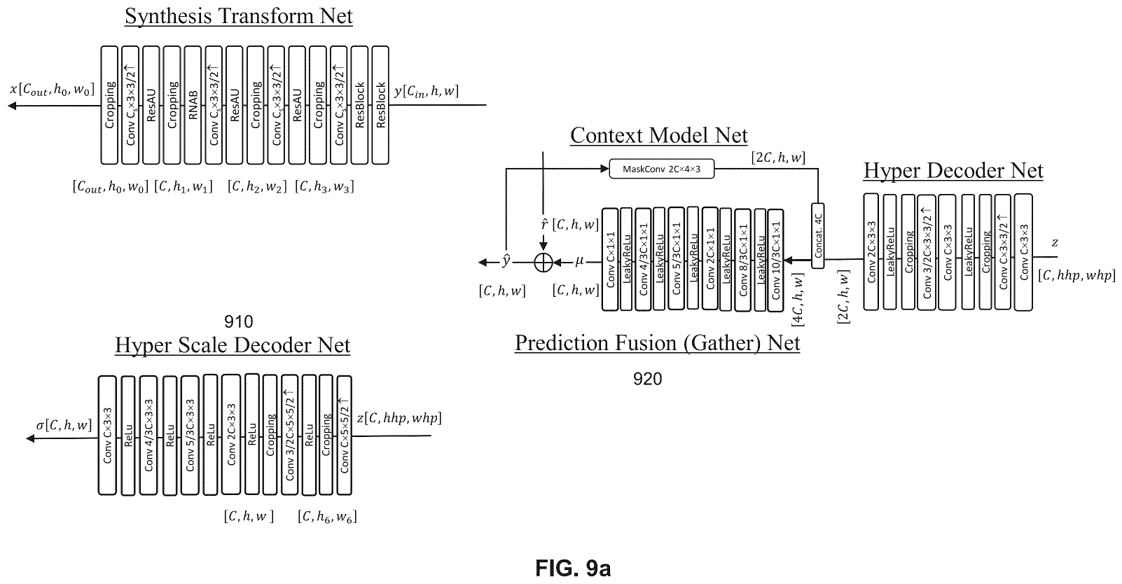

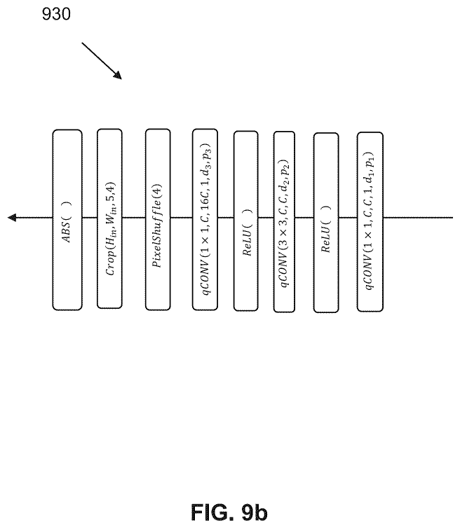

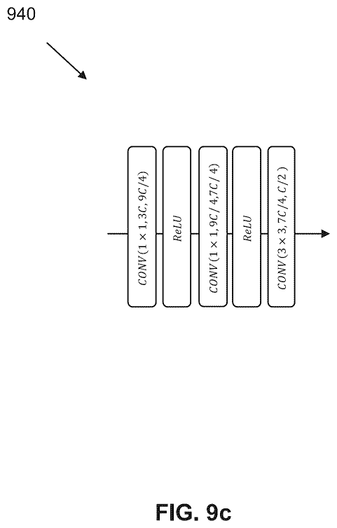

The encoder side may also include a hyper encoder net. For example, as shown in FIG. 8, a hyper encoder net may include a sequence of two convolutions with down-sampling stride 2, three convolutions without tensor size change and ReLU as activation (For example, ReLU in FIG. 10). A size of the tensor in different parts of analysis transform are shown in FIG. 8. FIG. 9 also shows an analysis transform net of every down-sampling of convolutions that are preceded by a padding layer.

The bitsream #1 and bitsream #2 (on FIG. 7A) are coded/decoded using a fixed probability density model. The discretized cumulative distribution function is stored in a predetermined fixed table and is used to parse the quantized hyper prior latent \hat{z}. The quantized hyper prior latent \hat{z} is then processed by the Hyper Scale Decoder Net, which is a NN-based subnetwork that is used to generate Gaussian variances σ. Afterwards the quantized residual latent samples \hat{r} are obtained by applying arithmetic decoding on the second bitstream (bitsream #3 and bitsream #4), assuming the zero-mean Gaussian distribution N(0,σ²). It is noted that the entire entropy decoding process can be performed before latent sample prediction process begins.

FIG. 9a depicts block diagrams illustrating decoder-side sub-networks. Hyper Scale decoder Net 910 includes a sequence of two inverse convolutions with up-sampling stride 2, two convolutions without tensor size change and leaky ReLU (for example, LeakyReLU in FIG. 10) as activation Size of the tensor in different parts of analysis transform as is shown below the block diagram in FIG. 9. Symmetrically to Hyper encoder for each up-sampling convolution layer is followed by a cropping operation.

The whole process as is depicted in FIG. 9 as Prediction Fusion Net 920, which is also called as Prediction Gather Net. At the beginning of the latent sample prediction process, an inverse transform operation is performed on the hyper prior latent \hat{z} by the Hyper Decoder Net 910. The output of this process is concatenated with the output of the Context Model sub-network, which is then processed by the Prediction Fusion Net 920 to generate the prediction values μ. The prediction values are then added to the quantized residual samples \hat{r} to obtain the quantized latent samples ŷ.

Hyper Decoder Net (FIG. 9) includes a sequence of two inverse convolutions with up-sampling stride 2, three convolutions without tensor size change and leaky ReLU as activation. Symmetrically to Hyper encoder each up-sampling convolution layer is followed by a cropping operation.

Prediction Fusion Net 920 (FIG. 9) consists of a sequence of convolutions with gradually reduced number of channels.

Synthesis transform Net, as an example shown in FIG. 9, includes the sequence of 4 convolutions with up-sampling stride 2. Size of the tensor in different parts of synthesis transform net is shown on FIG. 9. One can notice that peak memory usage (also maximum amount of multiplication operations) appears before the last up-sampling convolutional layer. Number of channels for primary component Synthesis transform is as follows:=Cᵢₙ=128; Cₒᵤₜ=1. Number of channels for secondary components Synthesis transform is as follows: C=64; Cᵢₙ=128+64; Cₒᵤₜ=2.

It is noted that the latent sample prediction process is an auto-regressive process. However, quantized latent samples ŷ[:,i,j] in different rows can be processed in parallel. Alternative architectures for a hyper scale decoder sub-net 930 and a prediction fusion sub-net 940 in which embodiments of the present disclosure may, advantageously, be implemented are illustrated in FIGS. 9b and 9c, respectively.

Commonly used NN elements in FIGS. 8 and 9a, 9b, and 9c are shown in FIG. 10.

In JPEG AI VMuC-2.0, for example, in “Hyper Scale Decoder Net” and “Prediction Fusion (Gather) Net”, tensor size in channel dimension is a fractional number. In actual implementation a fractional number is rounded down and data is lost.

The problem is specific for CCS architecture adopted to JPEG AI VMuC-2.0, since the number of channels in the prior component pipeline (Cp) and secondary component pipeline (Cs) is not a multiple of 3. In almost all papers a channel number of C=192 (multiple of 3 since three colors RGB are coded together) is used.

The number of channels in a neural network (NN) sub-network often changes from layer to layer. A typical example is a gather sub-network, which operates as fusion of multiple hypothesis produced by preceding sub-networks. In this disclosure, the terms “gather” and “fusion” have the same meaning.

According to embodiments NN design principles include at least one of the conditions below:
1. If inside a sub-network the number of channels changes from layer to layer then it (the number of channels) must be an integer at every layer. Sub-network design with a number of channels Cₒᵤₜ=p*Cᵢₙ/q only if Cᵢₙ is a multiple of q. This may prevent data loss. As an example, q equals to 2.
2. If inside a sub-network the number of channels changes then it shall not be decreasing and then increasing in one sub-network:
   If tensor size (in processing order) C0, C1, . . . , Ck−1, Ck, . . . . CN then.
      C0>C1> . . . >Ck−1>Ck> . . . >CN means reduction of tensor size after input data utilized→allowed.
      C0<C1< . . . <Ck−1>Ck> . . . >CN means increment of tensor size for temporal hypothesis storage then reduction of tensor size after input data utilized→allowed.
      C0>C1> . . . <Ck−1<Ck> . . . >CN means reduction of tensor size (data loss) and then increment of tensor size (data creation)→shall not be allowed
This may prevent data loss and further recreation the data.
3. If inside a sub-network the number of channels changes then at each layer the number of channels must be a multiple chunk size. The chunk size is different for each particular implementation of dedicated hardware for neural network algorithms. A typically used chuck size=16, currently. In near future with progress of dedicated hardware incrementors a chunk size of 32 is to be expected. Chunk size is a power of 2.
   This may provide efficient NPU/GPU resources utilization.
   In order to realize the NN design principles described above, the embodiment of the disclosure provides a neural network, as, for example, shown in FIGS. 1-10. The neural network includes a first neural network layer and a second neural network layer. The neural network layer may obtain a first number of channels (Cᵢₙ) as input, and output a second number of channels (Cₒᵤₜ), wherein the first number of channels is different from the second number of channels, Cₒᵤₜ=p*Cᵢₙ/q, Cᵢₙ is multiple of q, Cᵢₙ, Cₒᵤₜ, p and q are integers. The second neural network layer is configured to obtain the second number of channels (Cₒᵤₜ) as input.
   As an example, the first neural network layer is a hyper scale decoder net as shown in FIGS. 7 and 9. Or the first neural network layer may be a prediction fusion (Gather) net, as. for example, shown in FIGS. 7 and 9.
   The first neural network layer includes data paths for a primary component or/and a secondary component.

The second neural network layer may have a similar structure to that of the first neural network layer.

The neural network may further include a third neural network layer. The second neural network layer is further configured to output a third number of channels (C′); the third neural network layer is configured to obtain the third number of channels (C′), wherein C′=p′*Cₒᵤₜ/q′, C′is multiple of q′, C′, p′ and q′ are integers.

The third neural network layer may have a similar structure to that of the first neural network layer.

As explained above, the third number of channels is smaller than the second number of channels, and the second number of channels is smaller than the first number of channels; or the third number of channels is smaller than the second number of channels, and the second number of channels is larger than the first number of channels; or
the third number of channels is larger than the second number of channels, and the second number of channels is larger than the first number of channels.

However, it is not allowed that the third number of channels is larger than the second number of channels, and the second number of channels is smaller than the first number of channels.

In a possible implementation, the first number of channels (Cᵢₙ) and the second number of channels (Cₒᵤₜ) are multiple of a chunk size. 8. The chunk size may be 16 or 32.

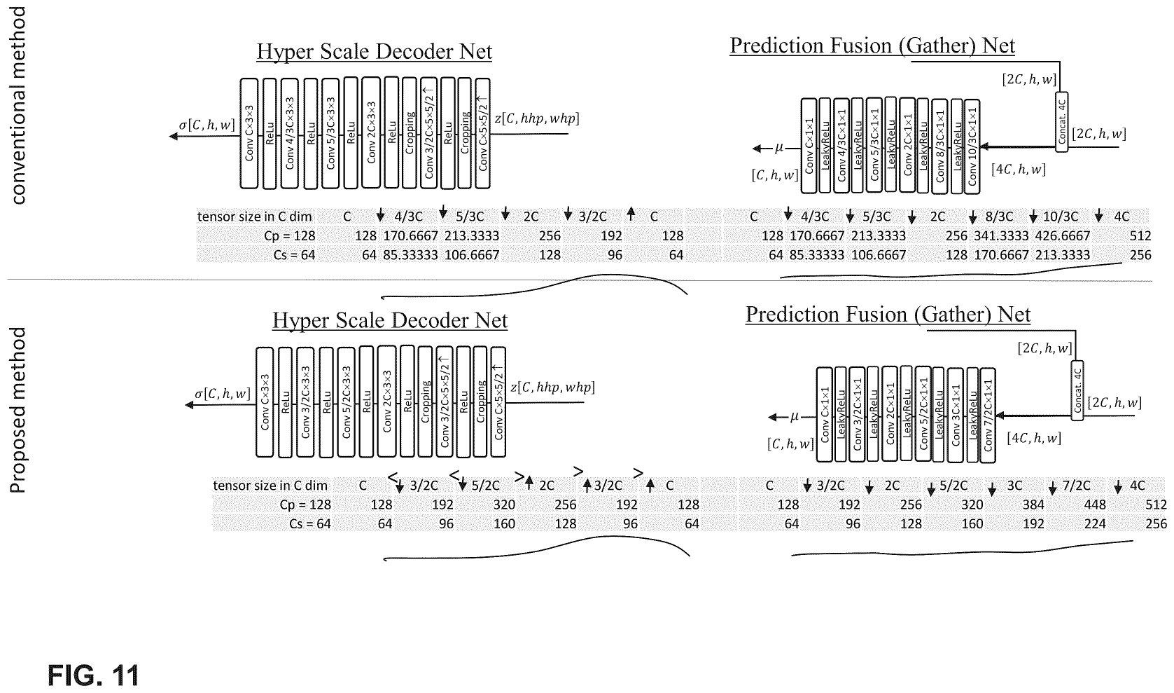

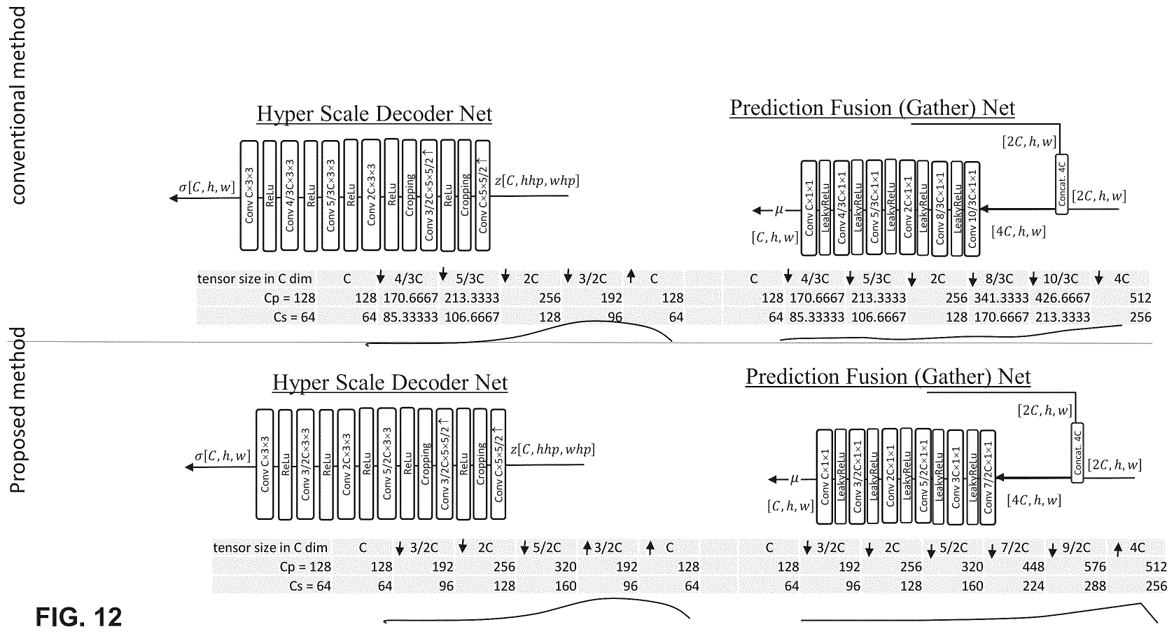

Two examples are provided in FIGS. 11 and 12 for exemplary implementations of embodiments of the present disclosure. As shown in FIGS. 11 and 12, in the conventional method, the output of Conv 5/3C×3×3 in Hyper Scale Decoder Net would be 213.3333 when Cp=128, and would be 106.6667 when Cs=64. Thus, the output of the number of channels are non-integers. In the embodiment provided in FIG. 11, the output of Conv 5/2C×3×3 in Hyper Scale Decoder Net would be 320 when Cp=128, would be 160 when Cs=64. Thus, the output of the number of channels are integers.

Similarly, in Prediction Fusion (Gather) Net, in the conventional method, the output of Conv 10/3C×1×1 in Hyper Scale Decoder Net would be 426.6667 when Cp=128, would be 213.3333 when Cs=64. Thus, the output of the number of channels are non-integer. In the embodiment provided in FIG. 11, the output of Conv 7/2C×1×1 would be 448 when Cp=128,would be 224 when Cs=64. Thus, the output of the number of channels are integers.

FIG. 11 is an optional design for the Hyper Scale Decoder Net, and Prediction Fusion (Gather) Net. FIG. 12 provides another choice for the Hyper Scale Decoder Net, and Prediction Fusion (Gather) Net. The Hyper Scale Decoder Net in FIG. 11 can also work together with the Hyper Scale Decoder Net and/or Prediction Fusion (Gather) Net in FIG. 12. Similarly, the Prediction Fusion (Gather) Net in FIG. 11 can also work together with the Hyper Scale Decoder Net and/or Prediction Fusion (Gather) Net in FIG. 12. The net is also referred to as a neural network layer, or a neural network sub-network.

The order of implementation in FIGS. 11 and 12 is from right to left.

In the example of Hyper Scale Decoder Net in FIG. 11, p/q=2, and p′/q′=5/2. In the example of Hyper Scale Decoder Net in FIG. 12, p/q=5/2, and p′/q′=2.

As the example shown in FIG. 11, the tensor sizes for number of channels (C) in the Hyper Scale Decoder Net may include 3/2C, 2C, 5/2C and 3/2C in order. As the example shown in FIG. 12, the tensor sizes for number of channels (C) in the Hyper Scale Decoder Net may include 3/2C, 5/2C, 2C and 3/2C in order.

In the example of Prediction Fusion (Gather) Net in FIG. 11, p/q=7/2, and p′/q′=3. In the example of Prediction Fusion (Gather) Net in FIG. 12, p/q=9/2, and p′/q′=7/2.

As the example shown in FIG. 11, the tensor sizes for number of channels (C) in the Prediction Fusion (Gather) Net may include 7/2C, 3C, and 5/2C in order. As the example shown in FIG. 12, the tensor sizes for number of channels (C) in the Prediction Fusion (Gather) Net may include 9/2C, 7/2C, and 5/2C in order.

In the present disclosure, by keeping the number of channels as an integer at every layer inside the sub-network the number of channels is variable and can prevent data loss. By keeping number of channels as multiple chunk sizes at every layer inside the sub-network the number of channels is variable and provides an efficient NPU/GPU resource utilization. Further, it does not allow that the third number of channels is larger than the second number of channels, and the second number of channels is smaller than the first number of channels. This can prevent data loss and further recreation of the data.

### Functional Modules

### Variable Bitrate Module

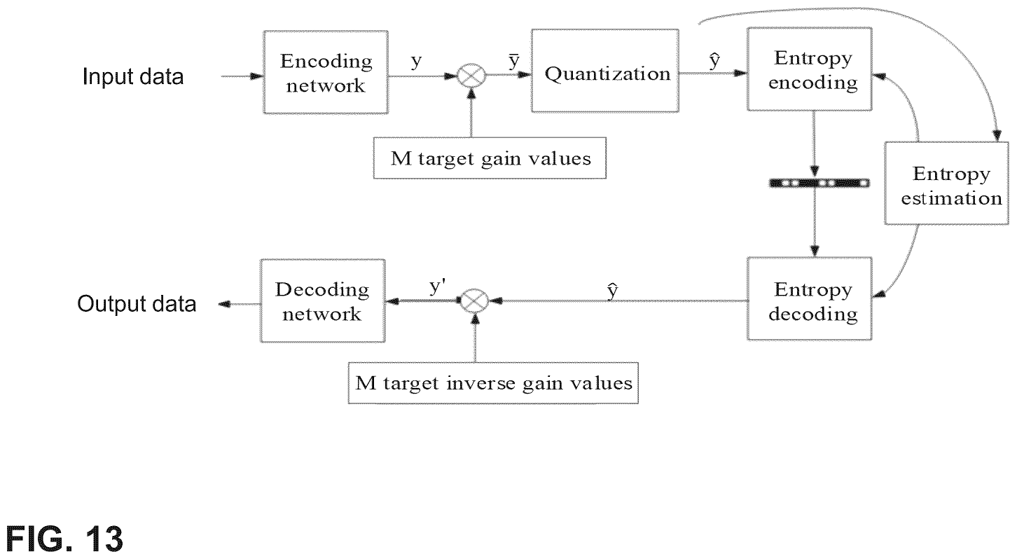

An encoder can output bitstreams at different bit rates. Therefore, in some methods, an output of an encoding network is scaled (for example, each channel is multiplied by a corresponding scaling factor that is also referred to as a target gain value), and an input of a decoding network is inversely scaled (for example, each channel is multiplied by a corresponding scaling factor reciprocal that is also referred to as a target inverse gain value), as shown in FIG. 13. The scaling factor may be preset. Different quality levels or quantization parameters correspond to different target gain values. If the output of the encoding network is scaled to a smaller value, a bitstream size may be decreased. Otherwise, the bitstream size may be increased.

### Color Format Transform

RGB and YUV are common color spaces. Conversion between RGB and YUV may be performed according to an equation specified in standards such as CCIR 601 and BT.709.

### Separate Structure for Luma and Chroma

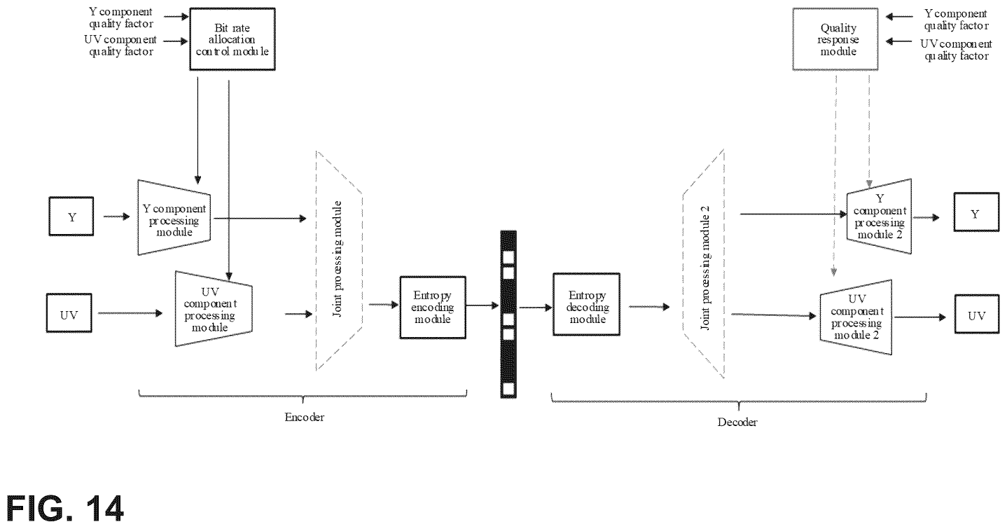

Some VAE-based codecs use the YUV color space as an input of an encoder and an output of a decoder, as shown in FIG. 14. A Y component indicates luma, and a UV component indicates chroma. Resolution of the UV component may be the same as or lower than that of the Y component. Typical formats include YUV4:4:4, YUV4:2:2, and YUV4:2:0. The Y component is converted into a feature map F_Y through a network, and an entropy encoding module generates a bitstream of the Y component based on the feature map F_Y. The UV component is converted into a feature map F_UV through another network, and the entropy encoding module generates a bitstream of the UV component based on the feature map F_UV. Under this structure, the feature map of the Y component and the feature map of the UV component may be independently quantized, so that bits are flexibly allocated for luma and chroma. For example, for a color-sensitive image, a feature map of a UV component may be less quantized, and a quantity of bitstream bits for a UV component may be increased, to improve reconstruction quality of the UV component and achieve better visual effect.

In some other methods, an encoder concatenates (concatenate) a Y component and a UV component and then sends to a UV component processing module (for converting image information into a feature map). In addition, a decoder concatenates a reconstructed feature map of the Y component and a reconstructed feature map of the UV component and then sends to a UV component processing module 2 (for converting a feature map into image information). In this method, a correlation between the Y component and the UV component may be used to reduce a bitstream of the UV component.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter of the present disclosure have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

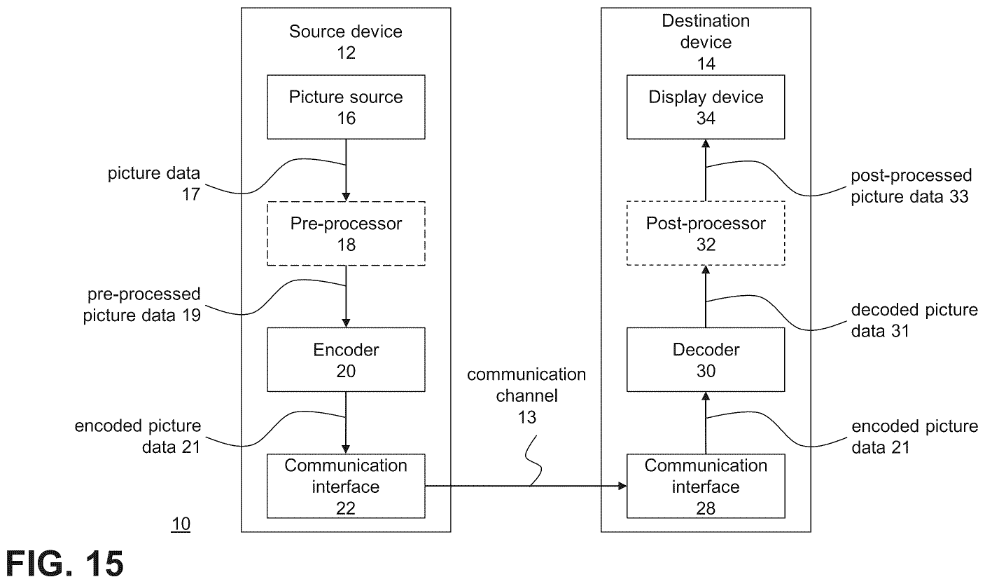

The corresponding system which may deploy the above-mentioned encoder-decoder processing chain is illustrated in FIG. 15. FIG. 15 is a schematic block diagram illustrating an example coding system, e.g. a video, image, audio, and/or other coding system (or short coding system) that may utilize techniques of this present disclosure. Video encoder 20 (or short encoder 20) and video decoder 30 (or short decoder 30) of video coding system 10 represent examples of devices that may be configured to perform techniques in accordance with various examples described in the present application. For example, the video coding and decoding may employ neural network such which may be distributed and which may apply the above-mentioned bitstream parsing and/or bitstream generation to convey feature maps between the distributed computation nodes (two or more).

As shown in FIG. 15, the coding system 10 comprises a source device 12 configured to provide encoded picture data 21 e.g. to a destination device 14 for decoding the encoded picture data 13.

The source device 12 comprises an encoder 20, and may additionally, i.e. optionally, comprise a picture source 16, a pre-processor (or pre-processing unit) 18, e.g. a picture pre-processor 18, and a communication interface or communication unit 22.

The picture source 16 may comprise or be any kind of picture capturing device, for example a camera for capturing a real-world picture, and/or any kind of a picture generating device, for example a computer-graphics processor for generating a computer animated picture, or any kind of other device for obtaining and/or providing a real-world picture, a computer generated picture (e.g. a screen content, a virtual reality (VR) picture) and/or any combination thereof (e.g. an augmented reality (AR) picture). The picture source may be any kind of memory or storage storing any of the aforementioned pictures.

In distinction to the pre-processor 18 and the processing performed by the pre-processing unit 18, the picture or picture data 17 may also be referred to as raw picture or raw picture data 17.

Pre-processor 18 is configured to receive the (raw) picture data 17 and to perform pre-processing on the picture data 17 to obtain a pre-processed picture 19 or pre-processed picture data 19. Pre-processing performed by the pre-processor 18 may, e.g., comprise trimming, color format conversion (e.g. from RGB to YCbCr), color correction, or de-noising. It can be understood that the pre-processing unit 18 may be optional component. It is noted that the pre-processing may also employ a neural network (such as in any of FIGS. 1 to 7) which uses the presence indicator signaling.

The video encoder 20 is configured to receive the pre-processed picture data 19 and provide encoded picture data 21.

Communication interface 22 of the source device 12 may be configured to receive the encoded picture data 21 and to transmit the encoded picture data 21 (or any further processed version thereof) over communication channel 13 to another device, e.g. the destination device 14 or any other device, for storage or direct reconstruction.

The destination device 14 comprises a decoder 30 (e.g. a video decoder 30), and may additionally, i.e. optionally, comprise a communication interface or communication unit 28, a post-processor 32 (or post-processing unit 32) and a display device 34.

The communication interface 28 of the destination device 14 is configured receive the encoded picture data 21 (or any further processed version thereof), e.g. directly from the source device 12 or from any other source, e.g. a storage device, e.g. an encoded picture data storage device, and provide the encoded picture data 21 to the decoder 30.

The communication interface 22 and the communication interface 28 may be configured to transmit or receive the encoded picture data 21 or encoded data 13 via a direct communication link between the source device 12 and the destination device 14, e.g. a direct wired or wireless connection, or via any kind of network, e.g. a wired or wireless network or any combination thereof, or any kind of private and public network, or any kind of combination thereof.

The communication interface 22 may be, e.g., configured to package the encoded picture data 21 into an appropriate format, e.g. packets, and/or process the encoded picture data using any kind of transmission encoding or processing for transmission over a communication link or communication network.

The communication interface 28, forming the counterpart of the communication interface 22, may be, e.g., configured to receive the transmitted data and process the transmission data using any kind of corresponding transmission decoding or processing and/or de-packaging to obtain the encoded picture data 21.

Both, communication interface 22 and communication interface 28 may be configured as unidirectional communication interfaces as indicated by the arrow for the communication channel 13 in FIG. 15 pointing from the source device 12 to the destination device 14, or bi-directional communication interfaces, and may be configured, e.g. to send and receive messages, e.g. to set up a connection, to acknowledge and exchange any other information related to the communication link and/or data transmission, e.g. encoded picture data transmission. The decoder 30 is configured to receive the encoded picture data 21 and provide decoded picture data 31 or a decoded picture 31.

The post-processor 32 of destination device 14 is configured to post-process the decoded picture data 31 (also called reconstructed picture data), e.g. the decoded picture 31, to obtain post-processed picture data 33, e.g. a post-processed picture 33. The post-processing performed by the post-processing unit 32 may comprise, e.g. color format conversion (e.g. from YCbCr to RGB), color correction, trimming, or re-sampling, or any other processing, e.g. for preparing the decoded picture data 31 for display, e.g. by display device 34.

The display device 34 of the destination device 14 is configured to receive the post-processed picture data 33 for displaying the picture, e.g. to a user or viewer. The display device 34 may be or comprise any kind of display for representing the reconstructed picture, e.g. an integrated or external display or monitor. The displays may, e.g. comprise liquid crystal displays (LCD), organic light emitting diodes (OLED) displays, plasma displays, projectors, micro LED displays, liquid crystal on silicon (LCoS), digital light processor (DLP) or any kind of other display.

Although FIG. 15 depicts the source device 12 and the destination device 14 as separate devices, embodiments of devices may also comprise both or both functionalities, the source device 12 or corresponding functionality and the destination device 14 or corresponding functionality. In such embodiments the source device 12 or corresponding functionality and the destination device 14 or corresponding functionality may be implemented using the same hardware and/or software or by separate hardware and/or software or any combination thereof.

As will be apparent for the skilled person based on the present description, the existence and (exact) split of functionalities of the different units or functionalities within the source device 12 and/or destination device 14 as shown in FIG. 15 may vary depending on the actual device and application.

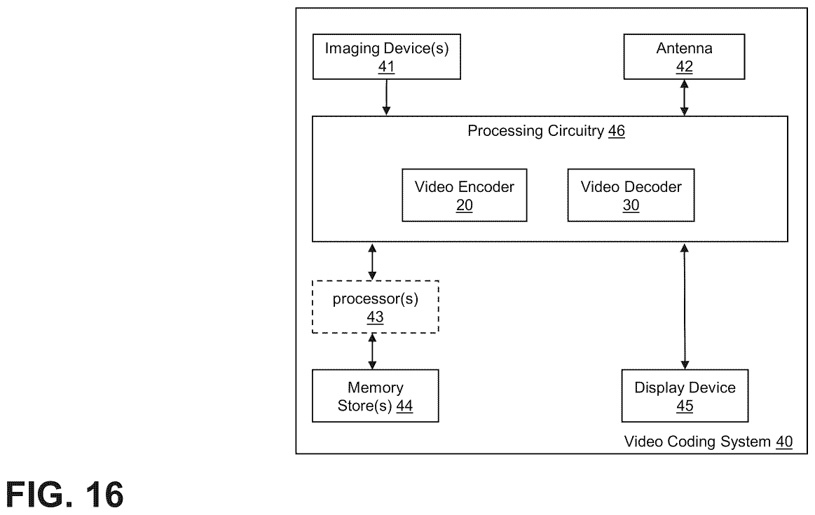

The encoder 20 (e.g. a video encoder 20) or the decoder 30 (e.g. a video decoder 30) or both encoder 20 and decoder 30 may be implemented via processing circuitry, such as one or more microprocessors, digital signal processors (DSPs), application-specific integrated circuits (ASICs), field-programmable gate arrays (FPGAs), discrete logic, hardware, video coding dedicated or any combinations thereof. The encoder 20 may be implemented via processing circuitry 46 to embody the various modules including the neural network or its parts. The decoder 30 may be implemented via processing circuitry 46 to embody any coding system or subsystem described herein. The processing circuitry may be configured to perform the various operations as discussed later. If the techniques are implemented partially in software, a device may store instructions for the software in a suitable, non-transitory computer-readable storage medium and may execute the instructions in hardware using one or more processors to perform the techniques of this disclosure. Either of video encoder 20 and video decoder 30 may be integrated as part of a combined encoder/decoder (CODEC) in a single device, for example, as shown in FIG. 16.

Source device 12 and destination device 14 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices (such as content services servers or content delivery servers), broadcast receiver device, broadcast transmitter device, or the like and may use no or any kind of operating system. In some cases, the source device 12 and the destination device 14 may be equipped for wireless communication. Thus, the source device 12 and the destination device 14 may be wireless communication devices.

In some cases, video coding system 10 illustrated in FIG. 15 is merely an example and the techniques of the present application may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In some examples, the encoding and decoding is performed by devices that do not communicate with one another, but simply encode data to memory and/or retrieve and decode data from memory.

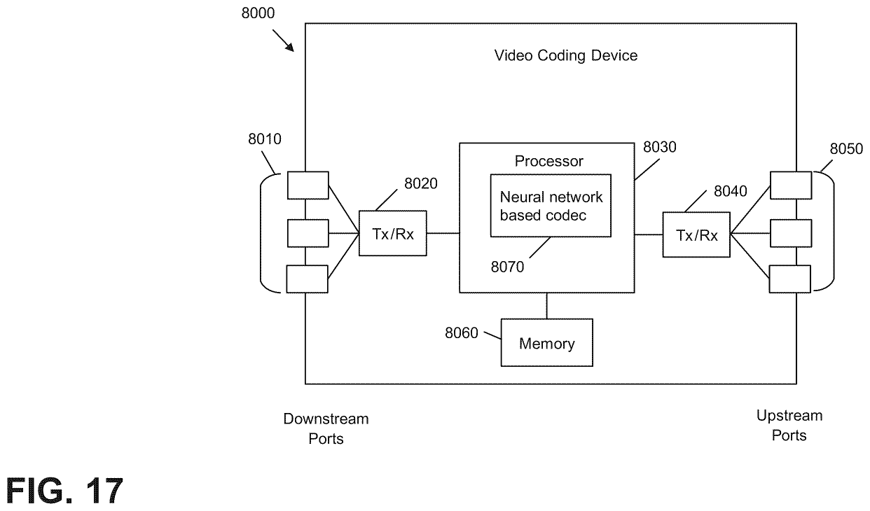

FIG. 17 is a schematic diagram of a video coding device 8000 according to an embodiment of the disclosure. The video coding device 8000 is suitable for implementing the disclosed embodiments as described herein. In an embodiment, the video coding device 8000 may be a decoder such as video decoder 30 of FIG. 15 or an encoder such as video encoder 20 of FIG. 15.

The video coding device 8000 comprises ingress ports 8010 (or input ports 8010) and receiver units (Rx) 8020 for receiving data; a processor, logic unit, or central processing unit (CPU) 8030 to process the data; transmitter units (Tx) 8040 and egress ports 8050 (or output ports 8050) for transmitting the data; and a memory 8060 for storing the data. The video coding device 8000 may also comprise optical-to-electrical (OE) components and electrical-to-optical (EO) components coupled to the ingress ports 8010, the receiver units 8020, the transmitter units 8040, and the egress ports 8050 for egress or ingress of optical or electrical signals.

The processor 8030 is implemented by hardware and software. The processor 8030 may be implemented as one or more CPU chips, cores (e.g., as a multi-core processor), FPGAs, ASICs, and DSPs. The processor 8030 is in communication with the ingress ports 8010, receiver units 8020, transmitter units 8040, egress ports 8050, and memory 8060. The processor 8030 comprises a neural network based codec 8070. The neural network based codec 8070 implements the disclosed embodiments described above. For instance, the neural network based codec 8070 implements, processes, prepares, or provides the various coding operations. The inclusion of the neural network based codec 8070 therefore provides a substantial improvement to the functionality of the video coding device 8000 and effects a transformation of the video coding device 8000 to a different state. Alternatively, the neural network based codec 8070 is implemented as instructions stored in the memory 8060 and executed by the processor 8030.

The memory 8060 may comprise one or more disks, tape drives, and solid-state drives and may be used as an over-flow data storage device, to store programs when such programs are selected for execution, and to store instructions and data that are read during program execution. The memory 8060 may be, for example, volatile and/or non-volatile and may be a read-only memory (ROM), random access memory (RAM), ternary content-addressable memory (TCAM), and/or static random-access memory (SRAM).

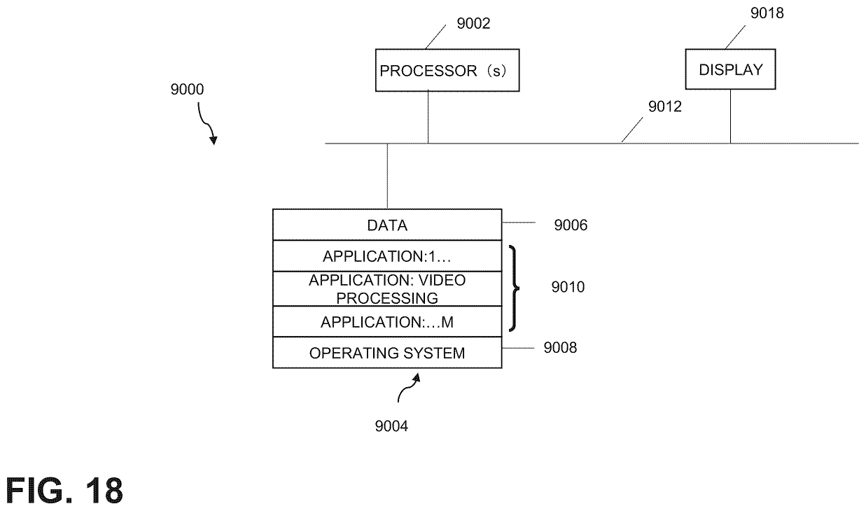

FIG. 18 is a simplified block diagram of an apparatus that may be used as either or both of the source device 12 and the destination device 14 from FIG. 15 according to an exemplary embodiment.

A processor 9002 in the apparatus 9000 can be a central processing unit. Alternatively, the processor 9002 can be any other type of device, or multiple devices, capable of manipulating or processing information now-existing or hereafter developed. Although the disclosed implementations can be practiced with a single processor as shown, e.g., the processor 9002, advantages in speed and efficiency can be achieved using more than one processor.

A memory 9004 in the apparatus 9000 can be a read only memory (ROM) device or a random access memory (RAM) device in an implementation. Any other suitable type of storage device can be used as the memory 9004. The memory 9004 can include code and data 9006 that is accessed by the processor 9002 using a bus 9012. The memory 9004 can further include an operating system 9008 and application programs 9010, the application programs 9010 including at least one program that permits the processor 9002 to perform the methods described here. For example, the application programs 9010 can include applications 1 through N, which further include a video coding application that performs the methods described here.

The apparatus 9000 can also include one or more output devices, such as a display 9018. The display 9018 may be, in one example, a touch sensitive display that combines a display with a touch sensitive element that is operable to sense touch inputs. The display 9018 can be coupled to the processor 9002 via the bus 9012.

Although depicted here as a single bus, the bus 9012 of the apparatus 9000 can be composed of multiple buses. Further, a secondary storage can be directly coupled to the other components of the apparatus 9000 or can be accessed via a network and can comprise a single integrated unit such as a memory card or multiple units such as multiple memory cards. The apparatus 9000 can thus be implemented in a wide variety of configurations.

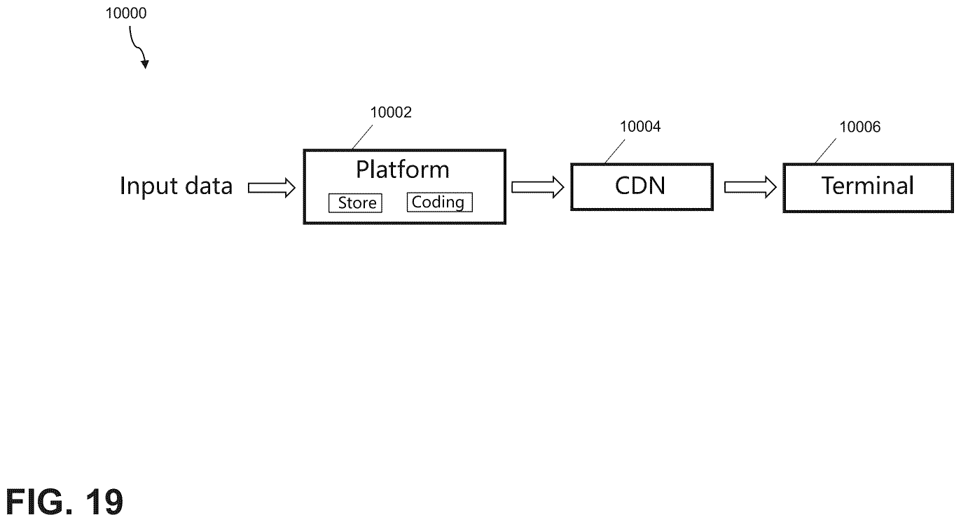

FIG. 19 is a block diagram of a video coding system 10000 according to an embodiment of the disclosure.

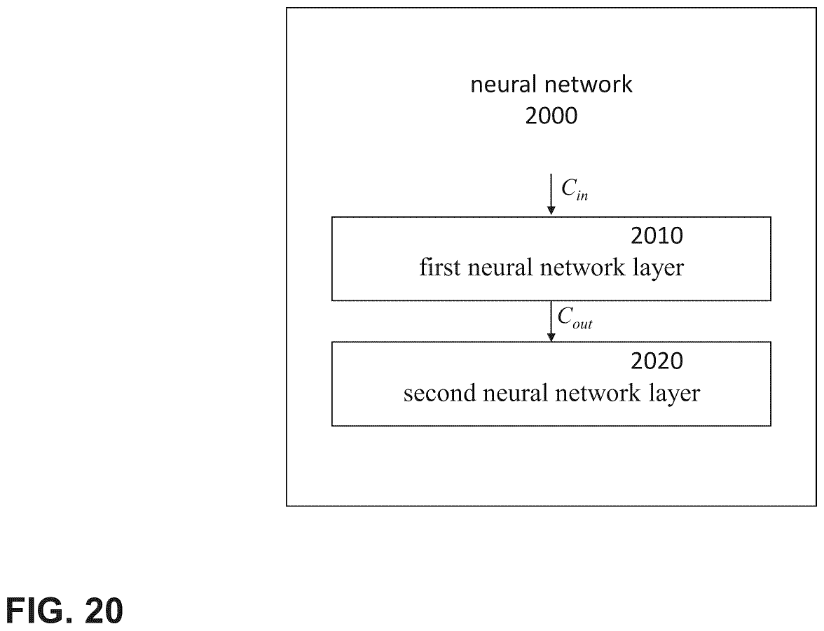

A neural network 2000 according to an embodiment of the present disclosure is illustrated in FIG. 20. The neural network 2000 comprises a first neural network layer 2010 and a second neural network 2020. The first neural network 2010 is configured to obtain (receive) a first number of channels Cᵢₙ as input and output a second number of channels Cₒᵤₜ, wherein the first number of channels is different from the second number of channels, and Cₒᵤₜ=p*Cᵢₙ/q, wherein Cᵢₙ is a multiple of q, and Cᵢₙ, Cₒᵤₜ, p and q are (positive) integers. The second neural network layer 2020 is configured to obtain (receive) the second number of channels Cₒᵤₜ as input. For example, the Cᵢₙ input channels may be or comprises color components, for example, RGB or YGB color components. For example, the Cₒᵤₜ output channels are in latent space. The condition Cₒᵤₜ=p*Cᵢₙ/q may also be fulfilled for output channels of the second neural network layer 2020 that receives as Cᵢₙ input channels the Cₒᵤₜ output channels of the first neural network layer 2010. According to an embodiment the condition is fulfilled for the respective Cᵢₙ input channels and the Cₒᵤₜ output channels of each neural network layer of the neural network 2000. In general, the number of channels or the number of output channels may be a multiple of 16 or 32.

Restricting the variable numbers of channels to integers significantly increases accuracy as well as speed of computation as compared to the art.

The neural network 2000 may be comprised be a neural network architecture of one of the examples shown in FIGS. 1 to 10 or one of the apparatuses shown in FIGS. 15 to 19.

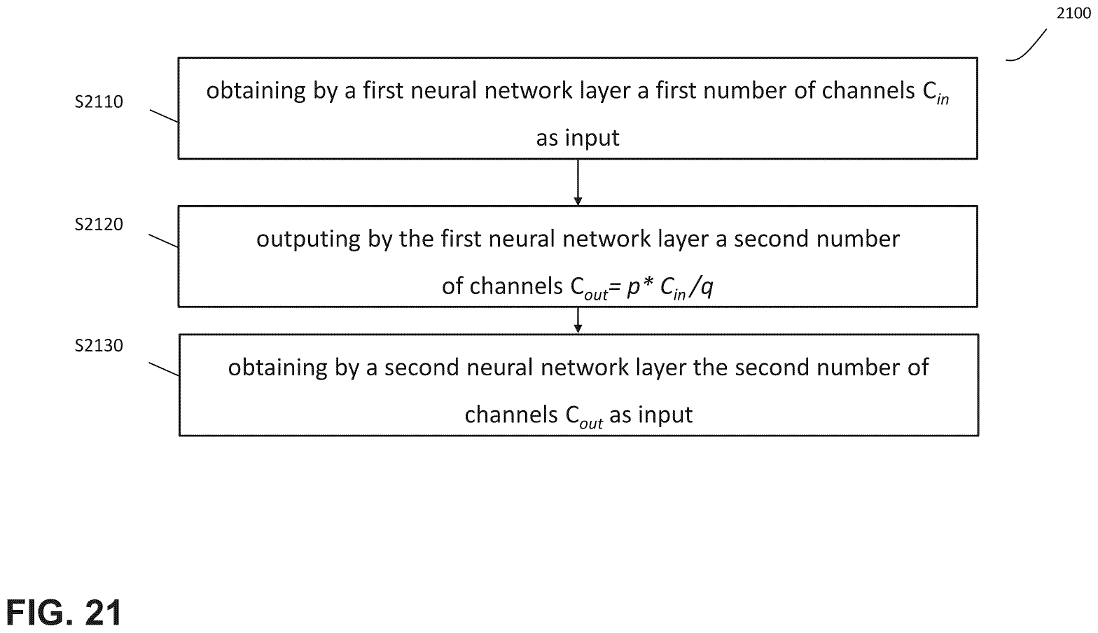

A method 2100 of operating a neural network with a variable number of channels of neural network layers is illustrated in FIG. 21. For example, the method 2100 is for operating the neural network 2000 comprising the first neural network layer 2010 and the second neural network layer 2020 illustrated in FIG. 20. The method 2100 comprises the steps of: obtaining (receiving) 2110 by a first neural network layer a first number of channels Cin as input, outputting 2120 by the first neural network layer a second number of channels Cout, wherein the first number of channels is different from the second number of channels, Cout=p*Cin/q, Cin is a multiple of q, and Cin, Cout, p and q are (positive) integers, and obtaining (receiving) 2130 by a second neural network layer the second number of channels Cout as input. According to an embodiment the method 2100 further comprises outputting C′=p′*Cout/q′, wherein C out is a multiple of q′, and C′, p′ and q′ are (positive) integers, channels by the second neural network layer. Video encoding or decoding methods may advantageously comprise the method 2100 illustrated in FIG. 21.

What is claimed is:

1. A neural network, comprising:
a first neural network layer configured to obtain a first number of channels Cᵢₙ as input, and output a second number of channels Cₒᵤₜ, wherein the first number of channels is different from the second number of channels, and Cₒᵤₜ=p*Cᵢₙ/q, wherein Cᵢₙ is a multiple of q, and Cᵢₙ, Cₒᵤₜ, p, and q are integers; and
a second neural network layer configured to obtain the second number of channels Cₒᵤₜ as input.

2. The neural network of claim 1, wherein q equals to 2.

3. The neural network of claim 1, wherein
the neural network further comprises a third neural network layer, wherein
the second neural network layer is further configured to output a third number of channels C′, and
wherein the third neural network layer is configured to obtain the third number of channels C′, wherein C′=p′*Cₒᵤₜ/q′, Cₒᵤₜ is a multiple of q′ and C′, and p′ and q′ are integers.

4. The neural network of claim 3, wherein
the third number of channels is smaller than the second number of channels, and the second number of channels is smaller than the first number of channels; or
the third number of channels is smaller than the second number of channels, and the second number of channels is larger than the first number of channels; or
the third number of channels is larger than the second number of channels, and the second number of channels is larger than the first number of channels.

5. The neural network of claim 3, wherein the neural network does not allow that the third number of channels is larger than the second number of channels, and wherein the second number of channels is smaller than the first number of channels.

6. The neural network of claim 3, wherein
$$p / q = 5 / 2 and p ’ / q ’ = 2 ; or$$
$$p / q = 2 and p ’ / q ’ = 5 / 2.$$

7. The neural network of claim 1, wherein the first number of channels Cᵢₙ and the second number of channels Cₒᵤₜ are multiples of a chunk size.

8. The neural network of claim 7, wherein the chunk size is 16 or 32.

9. The neural network of claim 1, wherein the first neural network layer or a sub-net of the neural network is one of a hyper scale decoder sub-net and a prediction fusion sub-net.

10. The neural network of claim 1, wherein the first neural network layer comprises data paths for at least one of a primary component and a secondary component.

11. The neural network of claim 1, wherein
the neural network further comprises at least one neural network sub-net consisting of consecutive neural network layers; and
for the at least one neural network sub-net at least one of the following conditions is fulfilled for the consecutive neural network layers for which the number of channels changes from one neural network layer to another:
a) each of the consecutive neural network layers is configured to output only a number of channels that is smaller or larger than a number of channels it receives from a previous one of the consecutive neural network layers in processing order;
b) the consecutive neural network layers consist of a first sub-set of consecutive neural network layers followed in processing order by a second sub-set of consecutive neural network layers, and wherein
i) each of the consecutive neural network layers of the first sub-set is configured to output only a number of channels that is larger than a number of channels it receives from a previous one of the consecutive neural network layers of the first sub-set in processing order, and
ii) each of the consecutive neural network layers of the second sub-set is configured to output only a number of channels that is smaller than a number of channels it receives from a previous one of the consecutive neural network layers of the second sub-set in processing order; and
c) the consecutive neural network layers consist of a first sub-set of consecutive neural network layers followed in processing order by a second sub-set of consecutive neural network layers, and wherein
i) each of the consecutive neural network layers of the first sub-set is configured to output only a number of channels that is smaller than a number of channels it receives from a previous one of the consecutive neural network layers of the first sub-set in processing order,
ii) none of the consecutive neural network layers of the second sub-set is configured to output a number of channels that is larger than a number of channels it receives from a previous one of the consecutive neural network layers of the second sub-set in processing order, and
iii) a first one of the consecutive neural network layers of the second sub-set in processing order is configured to only output a number of channels that is smaller than a number of channels it receives from a last one of the consecutive neural network layers of the first sub-set in processing order.

12. The neural network of claim 11, wherein each of the consecutive neural network layers is configured to output a number of channels that is a multiple of 16 or 32.

13. The neural network of claim 11, wherein the at least one neural network sub-net is one of a hyper scale decoder sub-net and a prediction fusion sub-net.

14. A computer-implemented method of operating a neural network with a variable number of channels of neural network layers, comprising:
obtaining, by a first neural network layer, a first number of channels Cᵢₙ as input,
outputting, by the first neural network layer, a second number of channels Cₒᵤₜ, wherein the first number of channels is different from the second number of channels, Cₒᵤₜ=p*Cᵢₙ/q, Cᵢₙ is a multiple of q, and Cᵢₙ, Cₒᵤₜ, p, and q are integers; and
obtaining, by a second neural network layer, the second number of channels Cₒᵤₜ as input.

15. A method of encoding data, comprising the steps of the computer-implemented method of operating the neural network according to claim 14.

16. A method of decoding encoded data, comprising the steps of the computer-implemented method of operating the neural network according to claim 14.

17. A computer program product comprising a program code stored on a non-transitory medium, wherein the program, when executed on one or more processors, performs the computer-implemented method according to claim 14.

18. An apparatus for decoding at least a portion of an encoded image, comprising processing circuitry configured for providing an entropy model comprising performing the steps of the computer-implemented method according to claim 14, processing a bitstream using a neural network based on the provided entropy model to obtain a latent tensor representing a component of the image, and processing the latent tensor to obtain a tensor representing the component of the image.

19. An apparatus for encoding at least a portion of an image, comprising the neural network according to claim 1.

20. An apparatus for decoding at least a portion of an encoded image, comprising the neural network according to claim 1.
